(19) United States
(12) Patent Application Publication
(10) Pub. No.: US 2026/0299683 A1
(43) Pub. Date: Oct. 1, 2026

(54) SYSTEMS AND METHODS FOR MULTIMODAL FREEFORM OBJECT IDENTIFICATION

(71) Applicant: Meta Platforms Technologies, LLC, Menlo Park, CA (US)

(72) Inventors: Jacqueline Fashimpaur, Redmond, WA (US); Ting Zhang, San Carlos, CA (US); Tanya Renee Jonker, Seattle, WA (US)

(21) Appl. No.: 19/632,263

(22) Filed: Mar. 28, 2026

Related U.S. Application Data
(60) Provisional application No. 63/779,338, filed on Mar. 28, 2025.

(51) Int. Cl. G06F 3/01; G06F 3/0346

(52) U.S. Cl. CPC G06F 3/013; G06F 3/017; G06F 3/0346

(57) ABSTRACT

A method of performing an object selection procedure is described. The method includes, in response to a user performing a selection input: receiving, from one or more cameras of a head-wearable device worn by the user, image data of a field-of-view of the user, the image data including one or more objects, receiving, from the head-wearable device, gaze data comprising a user gaze at one or more of the one or more objects, receiving, from a wrist-wearable device worn by the user, hand gesture data indicating the user performing a selection hand gesture, wherein the selection hand gesture has a gesture size and gesture shape, determining, based on the gaze data, the image data, the gesture size, and the gesture shape, at least a portion of the one or more objects, and presenting, to the user, an indication that the portion of the one or more objects is selected.

### RELATED APPLICATION

This application claims priority to U.S. Provisional Application Serial No. 63/779,338, filed Mar. 28, 2025, titled “Systems And Methods For Multimodal Freeform Object Identification,” which is incorporated herein by reference.

### TECHNICAL FIELD

This relates generally to object identification, more specifically, identifying objects using some combination of gaze inputs and gesture controls detected at one or more wearable devices.

### BACKGROUND

Wearable devices have limited means of recognizing both detailed and accurate selections of objects, which negatively impact user experience. Additionally, relying solely or mostly on gesture recognition in relation to objects captured by cameras has considerable user friction (e.g., circling a portion of an object with a hand is recognized as capturing the entire object and/or surrounding objects), decreasing their use.

As such, there is a need to address one or more of the above-identified challenges. A brief summary of solutions to the issues noted above are described below.

### SUMMARY

The systems and methods disclosed herein provide wearable devices that can accurately detect user selection of portions of one or more objects based on user inputs provided in various modalities. The systems and methods disclosed herein allow users to quickly select objects in their surroundings for further interaction. One example of a head-wearable device including one or more cameras and a wrist-wearable device for detecting user selection of portions of one or more objects based on user inputs provided in various modalities is described herein. This example head-wearable device and wrist-wearable device include executable instructions that, when executed by one or more processors, cause the one or more processors to perform operations. The operations include, in response to a user wearing the head-wearable device and the wrist-wearable device performing a selection input: receiving, from the one or more cameras of the head-wearable device, image data of a field-of-view of the user, the image data including one or more objects, receiving from the head-wearable device, gaze data comprising a user gaze at one or more of the one or more objects, receiving, from the wrist-wearable device, hand gesture data indicating the user performing a selection hand gesture, the selection hand gesture having a gesture size and a gesture shape, determining, based on the gaze data, the image data, the gesture size, and the gesture shape, at least a portion of the one or more objects, and presenting, to the user, an indication that the portion of the one or more objects is selected.

Instructions that cause performance of the methods and operations described herein can be stored on a non-transitory computer-readable storage medium. The non-transitory computer-readable storage medium can be included on a single electronic device or spread across multiple electronic devices of a system (computing system). A non-exhaustive list of electronic devices that can, either alone or in combination (e.g., a system), perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile–based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile–based garment, etc. For example, when an XR headset is described, it is understood that the XR headset can be in communication with one or more other devices (e.g., a wrist-wearable device, a server, intermediary processing device), which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A and 1B illustrate invocation of an object selection procedure, in accordance with some embodiments.

FIGS. 2A–2D illustrate invocation of an object selection procedure, in accordance with some embodiments.

FIG. 3 illustrates invocation of an object selection procedure, in accordance with some embodiments.

FIGS. 4A and 4B illustrate invocation of an object selection procedure, in accordance with some embodiments.

FIGS. 5A–5C illustrate invocation of an object selection procedure, in accordance with some embodiments.

FIG. 6 illustrates invocation of an object selection procedure, in accordance with some embodiments.

FIGS. 7A and 7B illustrate invocation of an object selection procedure, in accordance with some embodiments.

FIG. 8 illustrates invocation of an object selection procedure, in accordance with some embodiments.

FIG. 9 shows an example method flow chart for invocation of an object selection procedure, in accordance with some embodiments.

FIG. 10 shows an example method flow chart for invocation of an object selection procedure, in accordance with some embodiments.

FIGS. 11A, 11B, 11C-1, and 11C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities, and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and/or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)) is an electronic component that is responsible for executing instructions and controlling the operation of an electronic device (e.g., a wrist-wearable device, a head-wearable device, a handheld intermediary processing device (HIPD), a smart textile–based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid-state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid-state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein, biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Recognizing Objects from Multi-Modal User Inputs at One or More Wearable Devices

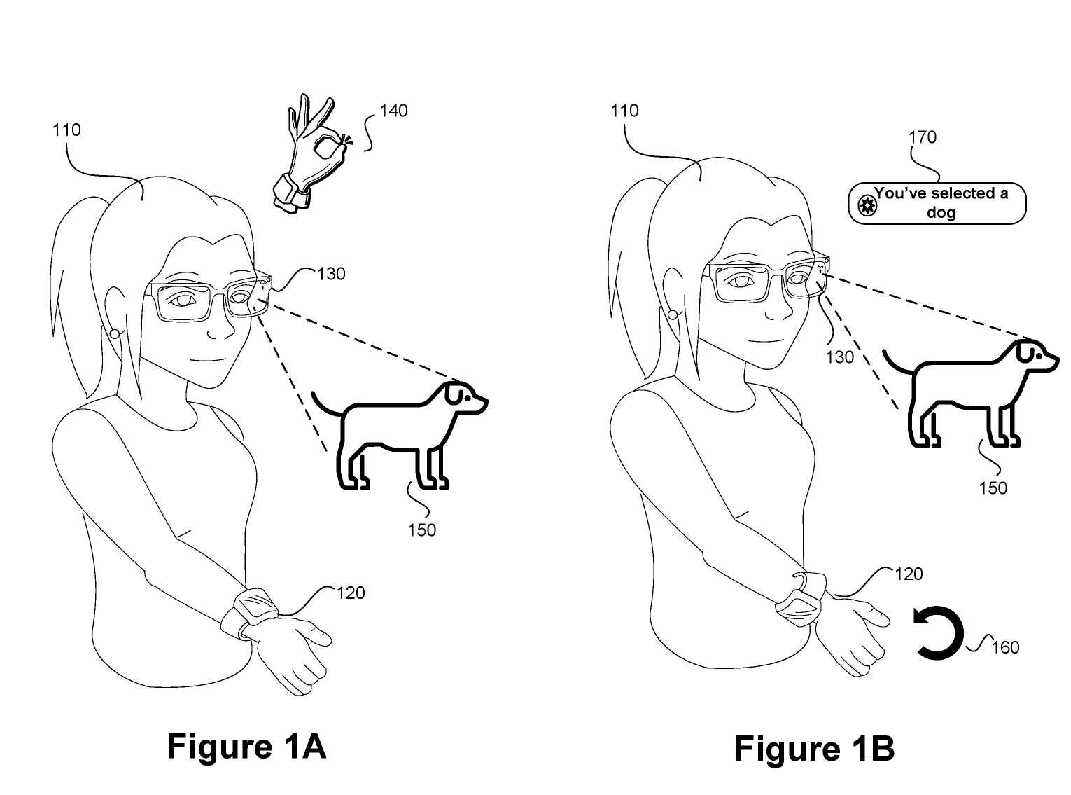

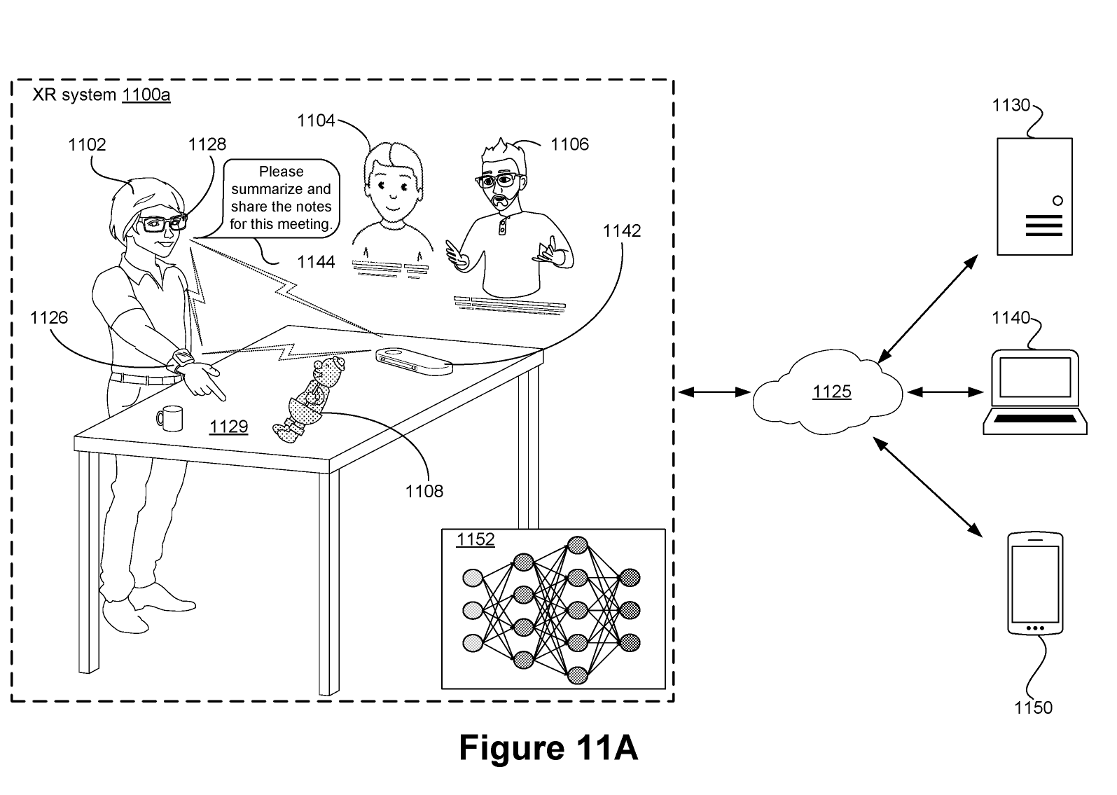

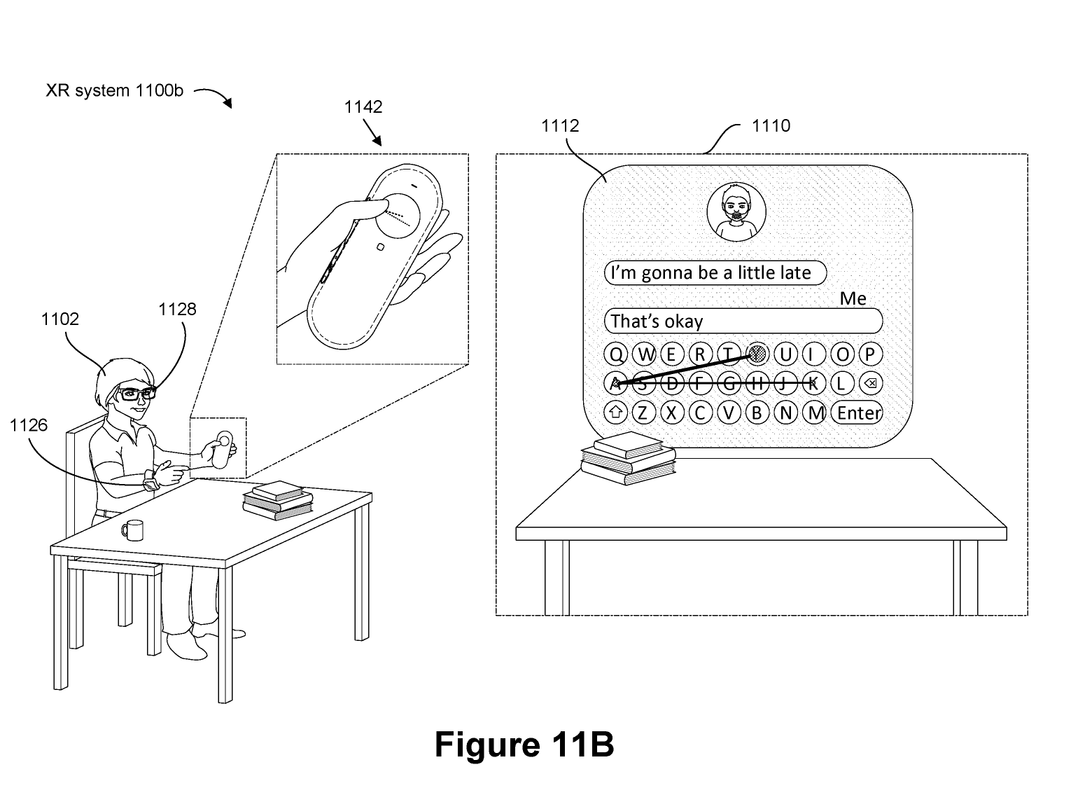

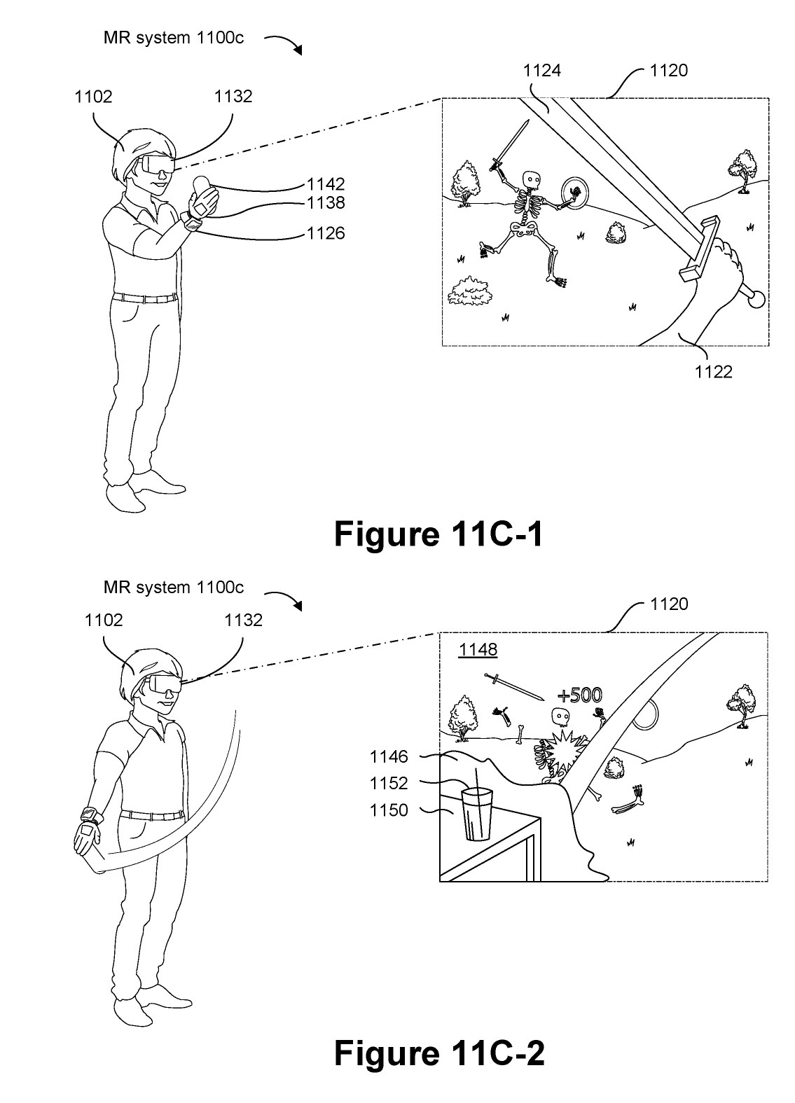

FIGS. 1A-8 illustrate a user 110 invocating an object selection procedure at one or more wearable devices, in accordance with some embodiments. The user 110 wearing a head-wearable device 130 and a wrist-wearable device 120 provides a hand gesture 140 at the wrist-wearable device 120 and gaze inputs at the head-wearable device 130. As described below in reference to FIG. 11A, the wrist-wearable device 120 can include one or more displays 125, an imaging device (e.g., a camera), a microphone, a speaker, input surfaces (e.g., touch input surface, mechanical inputs, etc.), and one or more sensors (e.g., biopotential sensors (e.g., EMG sensors), proximity sensors, ToF sensors, sensors of an IMU, capacitive sensors, strain sensors, etc.). In some embodiments, the wrist-wearable device 120 is one or more of a smart watch, a smart wristband, a smart armband, a smart ring, and/or another electronic device worn on a wrist and/or a forearm of the user 110. As described below in reference to FIG. 11A, the head-wearable device 130 is displayless, can include an imaging device (e.g., a camera), a microphone, a speaker, input surface (e.g., touch input surface, mechanical inputs, etc.), and one or more sensors (e.g., sensors of an IMU, capacitive sensors, proximity sensors, ToF sensors, strain sensors, EMG sensors, etc.). In some embodiments, the head-wearable device 130 is one or more of a pair of smart glasses, a smart head-wearable device, and/or another electronic device worn on a head and/or face of the user 110. The head-wearable device 130 and the wrist-wearable device 120 are communicatively coupled via a network (e.g., a cellular network, a near field connection, a Wi-Fi connection, a personal area network, etc.). In some embodiments, the head-wearable device 130 and/or the wrist-wearable device 120 are further communicatively coupled to an additional wearable device (e.g., a smart textile–based garment such as wearable bands, shirts, etc.). Additionally, the head-wearable device 130 and/or the wrist-wearable device 120 are further communicatively coupled to another electronic device, such as a server device, a handheld intermediary processing device (HIPD) (e.g., the HIPD 1142 described in reference to FIGS. 11A–11B), a computer 11 (e.g., the computer 1140, described in reference to FIG. 11A), mobile devices 11 (e.g., mobile devices 1150, described in reference to FIG. 11A), and/or other electronic devices described below in reference to FIGS. 11A–11C. The wearable devices and the electronic devices can be communicatively coupled via the network.

FIGS. 1A and 1B illustrate invocation of an object selection procedure, in accordance with some embodiments. FIG. 1A illustrates the user 110 performing hand gesture 140 while an object 150 (e.g., a dog) is within a field of view of the user 110. In some embodiments, the hand gesture 140 is a pinch gesture, a thumb slide on an index finger, an “ok” sign, a “peace” sign, a finger point, a fist, flexing one or more digits, or any other suitable hand gesture. In some embodiments, the hand gesture 140 is detected by one or more biopotential sensors (e.g., EMG sensors) included with the wrist-wearable device 120. In some embodiments, one or more cameras of the head-wearable device 130 capture the performance of hand gesture 140. In some embodiments, the hand gesture 140 causes the one or more cameras of the head-wearable device 130 to capture image data. In some embodiments, the image data comprises the field of view of the user 110. In some embodiments, if no objects are detected as being within the field of view of the user 110 (e.g., the one or more cameras of the head-wearable device 130 are not able to capture image data, the image data comprises shades of a single color, or the user 110 rapidly moves their head while performing the hand gesture 140 such that the one or more cameras cannot clearly capture an object), then a redo request is presented at one or more speakers of the head-wearable device, the wrist-wearable device, and/or the other device, the redo request comprising a request to the user 110 to re-perform hand gesture 140. In some embodiments, the object selection procedure can be invoked by a voice input from the user 110 (e.g., “I want to select an object”).

FIG. 1B illustrates the user 110 performing a selection gesture 160 after performance of hand gesture 140, in accordance with some embodiments. In some embodiments, while the user 110 gazes at the object 150, the user 110 performs selection gesture 160 such that the object 150 is encapsulated (e.g., circled) within the selection gesture 160. In some embodiments, the hand gesture 140 is maintained during the performance of the selection gesture 160. In some embodiments, the selection gesture is only able to be performed for a certain amount of time (e.g., four seconds) after the hand gesture 140 is performed, regardless of whether hand gesture 140 is maintained by the user 110. In some embodiments, the selection gesture 160 can be performed for longer than the certain amount of time as long as the user 110 maintains hand gesture 140. In some embodiments, the selection gesture 160 has a shape and a size that correspond to the user 110 intending to encapsulate the entirety of the object 150. In some embodiments, the shape and the size of the selection gesture 160 correspond to a portion of the object 150. In some embodiments, the shape and the size of the selection gesture 160, the gaze of the user 110 during the performance of the hand gesture 140 and/or the selection gesture 160, and image data comprising the field of view of the user 110 during the performance of the hand gesture 140 and/or the selection gesture 160 are analyzed to determine a selection of the object 150. In some embodiments, the gaze of the user 110 centers the selection input 160. In some embodiments, a selection indication 170 is presented at (i) one or more speakers of the head-wearable device 130, the wrist-wearable device 120, and/or the other device, and/or (ii) one or more displays of the wrist-wearable device 120 and/or the other device (e.g., “You’ve selected a dog”). In some embodiments, the head-wearable device 130 includes one or more displays and the selected portion of the object 150 is highlighted, and/or outlined at the one or more displays of the head-wearable device 130.

In some embodiments, the user 110 gazing at the object 150 upon performance of the hand gesture 140 determines which object of a plurality of objects the user 110 is intending to select, and the selection input 160 determines the portion of the object of the plurality of objects to select. In some embodiments, if the user 110 continuously changes their gaze to multiple objects within a short period of time (e.g., one second) before and after performing the hand gesture 140, then an indication is presented to the user 110 to focus their gaze on a single object (e.g., “I see you are trying to select something, please gaze at your selection target”).

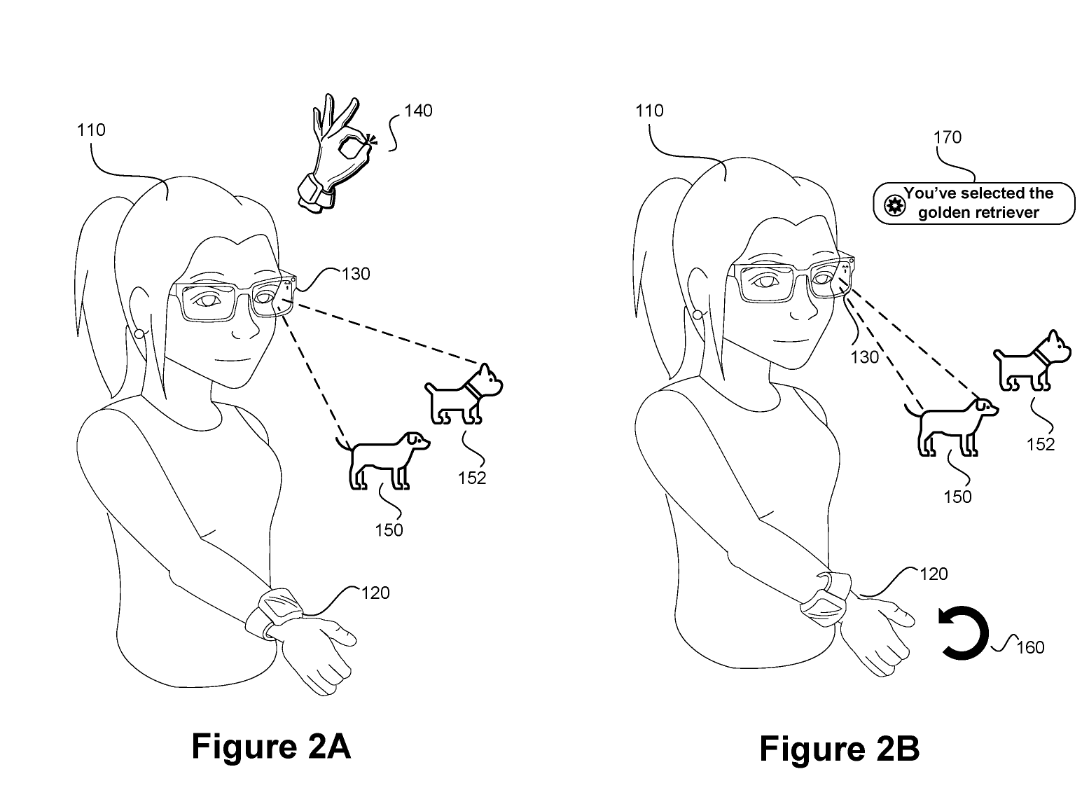

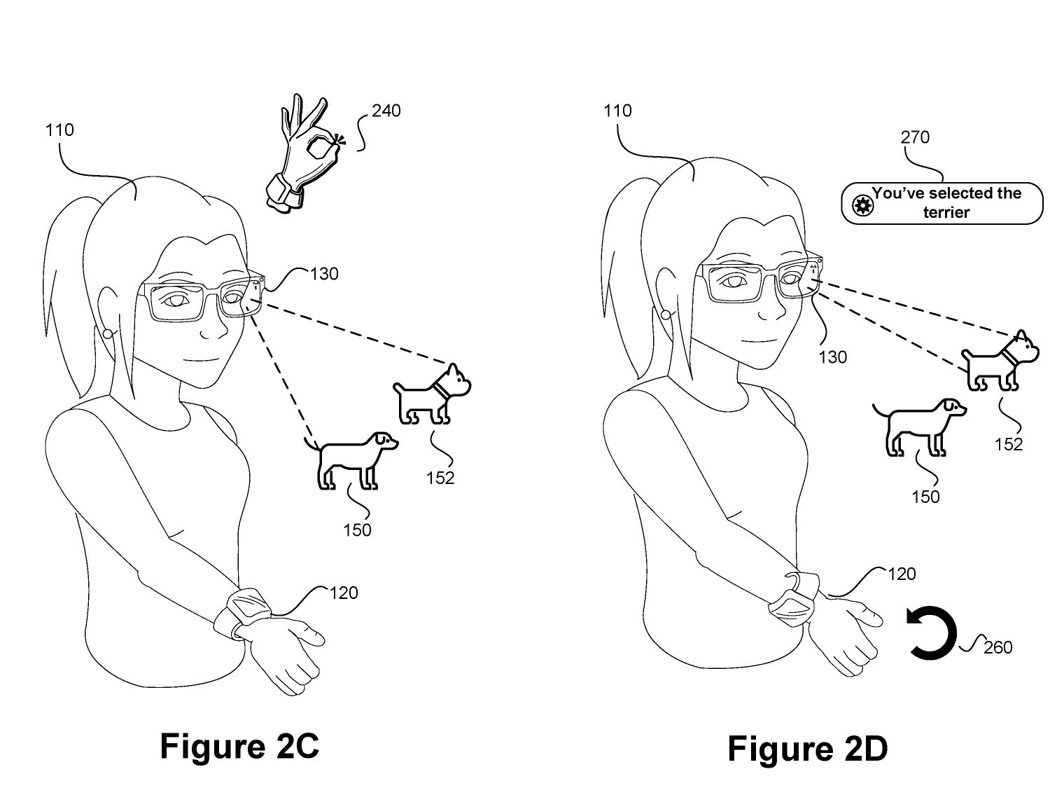

FIGS. 2A–2D illustrate invocation of an object selection procedure, in accordance with some embodiments. FIG. 2A illustrates the user 110 performing hand gesture 140 while the object 150 and object 152 are within the field of view of the user 110. In some embodiments, the user gazes at both object 150 and object 152 before performing hand gesture 140. In some embodiments, while both object 150 and object 152 are within the field of view of the user 110, the user 110 does not gaze at either object 150 or object 152 before performing hand gesture 140.

FIG. 2B illustrates the user 110 performing selection gesture 160 after performance of hand gesture 140, in accordance with some embodiments. In some embodiments, while the user performs selection gesture 160, the user 110 gazes at object 150 and not object 152. In some embodiments, the shape and size of the selection gesture 160 is centered around the gaze of the user 110 while the user 110 performs selection gesture 160. In some embodiments, when centered around the gaze of the user 110, selection gesture 160 is only large enough to capture object 150 and not object 152. In some embodiments, based on the shape and size of the selection gesture 160, the gaze of the user 110 during performance of the selection gesture 160, and the image data comprising the field of view of the user 110 during performance of the selection gesture 160, object 150 is determined to be selected. In some embodiments, the selection indication 170 provides extra detail about the selection in accordance with a determination that the extra detail distinguishes the selected object from other, unselected objects in the field of view of the user 110. For example, the selection indication 170 comprises “you’ve selected the golden retriever” when a selection indication stating “you’ve selected the dog” may confuse user 110 due to multiple dogs (but only one golden retriever) being within the field of view of the user 110. In some embodiments, the determination that the extra detail would be helpful to the user 110 is performed by an artificially intelligent (AI) assistant. In some embodiments, the AI assistant analyzes image data captured by the one or more cameras of the head-wearable device 130 comprising the field of view of the user 110 in order to determine the extra detail would be helpful to the user 110. In some embodiments, contextual user behavior data is captured upon performance of the hand gesture 140 and/or during the performance of selection gesture 160. For example, the user 110 states, “I want to know about the dog on the right” when performing the hand gesture 140 while gazing at object 150, and the user 110’s statement and gaze are analyzed in combination with the selection gesture 160 to determine that the user 110 intended to select object 150. In some embodiments, if the one or more cameras of the head-wearable device 130 are unable to provide image data to determine the gaze of the user 110, then the contextual user behavior data is used to determine the selection of the user 110. In some embodiments, if the one or more cameras of the head-wearable device 130 are unable to provide image data to determine the gaze of the user 110 and there is either insufficient or no contextual user behavior data, then the user 110 will be prompted to provide contextual user behavior data. For example, the one or more speakers of the head-wearable device 130 provide a request that the user 110 provide more information to determine whether the user 110 intends to select a portion of object 150 or object 152 (e.g., “which dog are you interested in selecting?”).

In some embodiments, the AI assistant is a machine-learning model local to the head-wearable device 130. In some embodiments, the AI assistant is a machine-learning model on an intermediary processing device communicatively connected to one or more of the head-wearable device 130, the wrist-wearable device 120, and the other device. In some embodiments, the AI assistant uses past selections, user queries, location data of the user 110, data associated with one or more applications of the wrist-wearable device 120, the head-wearable device 130, and/or the other device, information retrieved from a webpage, device information, one or more user settings, and/or context from image data captured by one or more cameras of the head-wearable device, wrist-wearable device, and/or the other device to generate the selection indication 170. For example, the user 110 selects a portion of a landscape comprising a tree with selection gesture 160, and the AI assistant generates selection indication 170 indicating what type of tree is selected based on the location of the user 110 and the details of the tree captured by one or more cameras of the head-wearable device 130.

FIGS. 2C and 2D illustrate the user 110 performing a second hand gesture 240 and second selection gesture 260, in accordance with some embodiments. In some embodiments, second hand gesture 240 is distinct from hand gesture 140, but still invokes the object selection procedure. In some embodiments, the selection gesture 160 and the second selection gesture 260 are distinct shapes and sizes (e.g., a lasso, an oval, a square, or a triangle) but still encapsulate an object within the field of view of the user 110. In some embodiments, the second selection gesture 260 is centered around the gaze of the user 110 and is only large enough to encapsulate the object 152. In some embodiments, based on the shape and the size of the second selection gesture 260, the gaze of the user 110 during performance of the second selection gesture 260, and the image data comprising the field of view of the user 110 during performance of the second selection gesture 260, object 152 is determined to be selected. In some embodiments, a second selection indication (e.g., “You’ve selected the terrier”) is presented at (i) one or more speakers of the head-wearable device 130, the wrist-wearable device 120, and/or the other device, and/or (ii) one or more displays of the wrist-wearable device 120 and/or the other device.

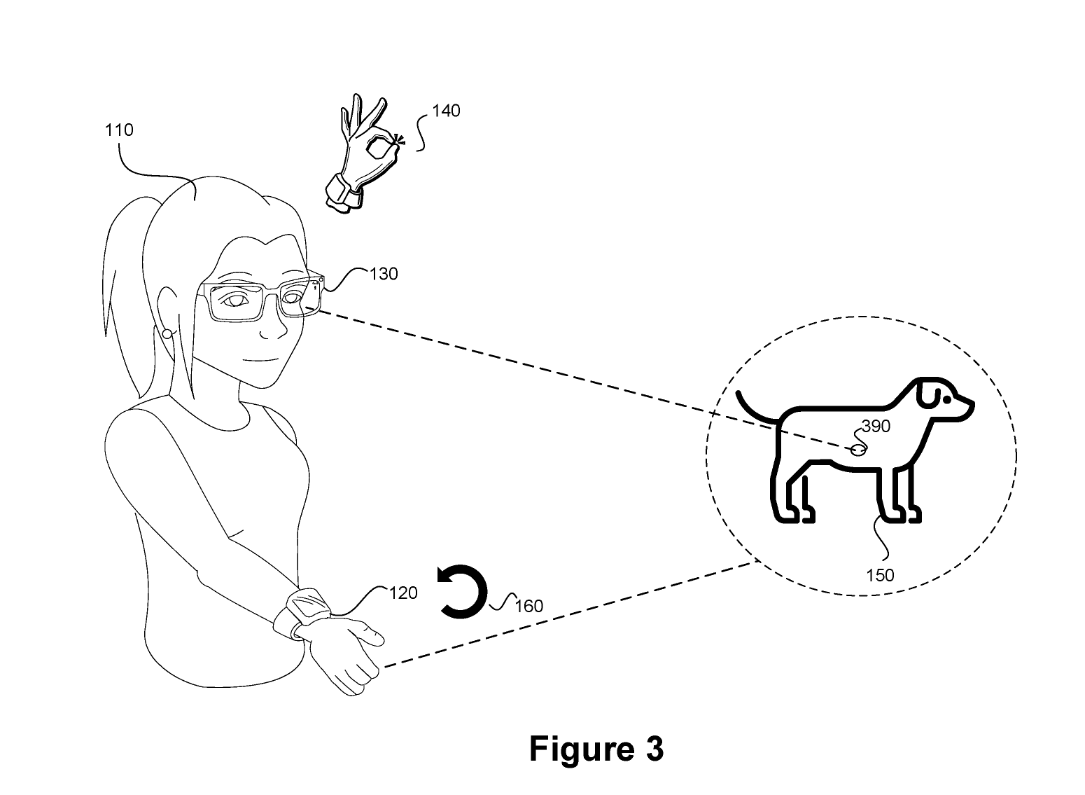

FIG. 3 illustrates invocation of an object selection procedure, in accordance with some embodiments. In some embodiments, the user 110 performs hand gesture 140 while gazing at object 150, the gazing comprising a gaze input 390. The user 110 then performs selection gesture 160. In some embodiments, selection gesture 160 is centered around gaze input 390. In some embodiments, the selection gesture 160 is anchored to the gaze input 390, even if the user 110 gazes at another object and not object 150 while performing the selection gesture 160. In some embodiments, if the user 110 looks away after performing hand gesture 140 such that object 150 is no longer in the field of view of the user 110 but the user 110 performs selection gesture 160, the selection is still determined to be at least a portion of object 150. In some embodiments, the user 110 must maintain the object 150 within the field of view of the user 110 while performing selection gesture 160, even if the user 110 is not gazing at object 150 while performing selection gesture 160.

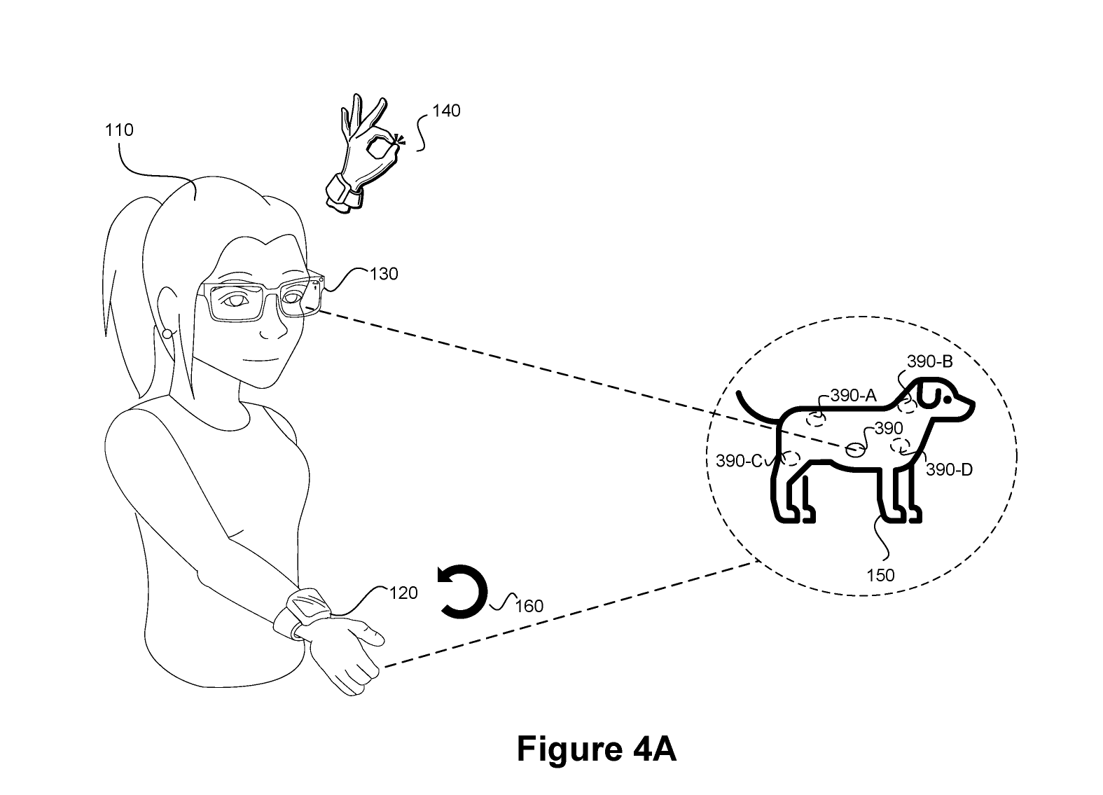

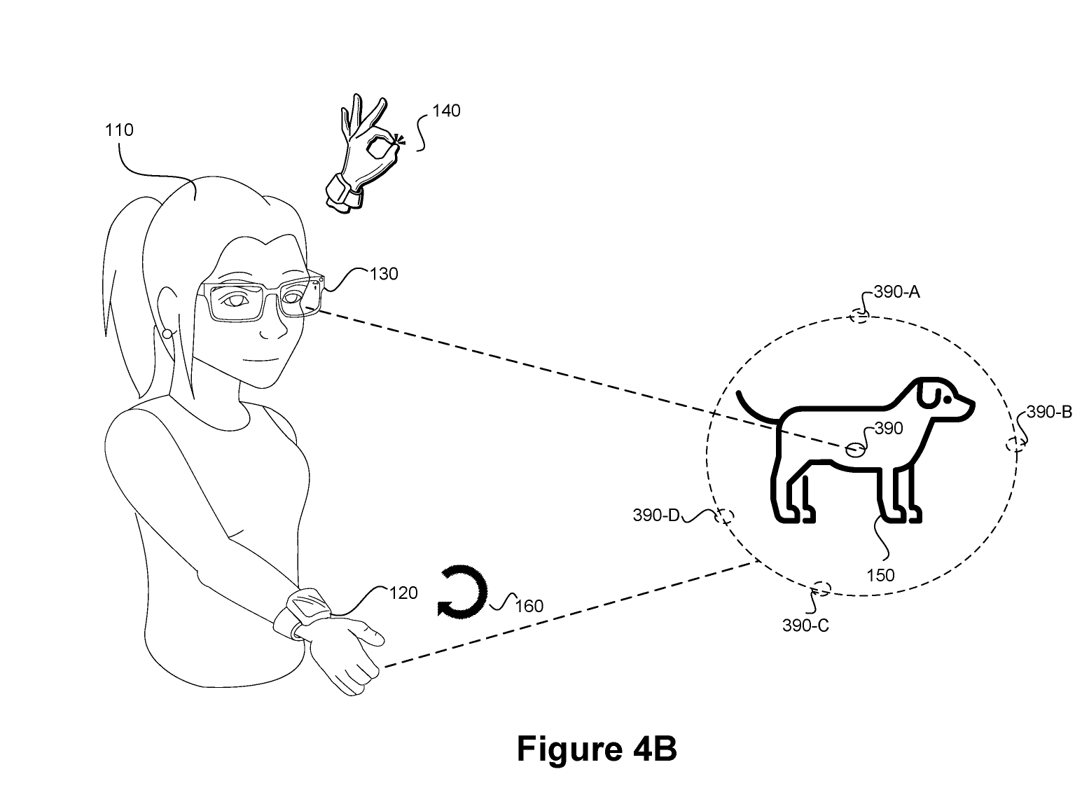

FIGS. 4A and 4B illustrate invocation of an object selection procedure, in accordance with some embodiments. FIG. 4A illustrates the user 110 performing hand gesture 140 while gazing at object 150 at gaze input 390. In some embodiments, multiple gaze inputs 390-A, 390-B, 390-C, 390-D are captured during performance of selection gesture 160. In some embodiments, the shape and size of the selection gesture 160 are averaged with the multiple gaze inputs 390-A, 390-B, 390-C, 390-D to determine the portion of the object 150 that the user 110 intends to select. In some embodiments, the multiple gaze inputs 390-A, 390-B, 390-C, 390-D are captured prior to the performance of the hand gesture 140 and the gaze input 390 and are analyzed to determine which object of a plurality of objects the user 110 intends to select with selection gesture 160. In some embodiments, the anchor coordinate is determined by computing an average distance of the multiple gaze inputs 390-A, 390-B, 390-C, 390-D. In some embodiments, the selection portion of the object 150 that the user 110 intends to select is based on the anchor coordinate. In some embodiments, the gaze of the user 110 is captured while the user 110 performs the selection gesture 160, and the multiple gaze inputs 390-A, 390-B, 390-C, 390-D are gaze inputs randomly sampled from the gaze of the user 110 during the performance of the selection gesture 160. In some embodiments, the multiple gaze inputs 390-A, 390-B, 390-C, 390-D are sampled after a threshold amount of time has occurred during the performance of the selection gesture 160 (e.g., at every second, a gaze input is sampled). In some embodiments, the shape and size of the selection gesture 160, the gaze input 390, the multiple gaze inputs 390-A, 390-B, 390-C, and 390-D, and/or the image data captured by the head-wearable device 130 determine the intended selection by the user 110 of at least a portion of object 150.

FIG. 4B illustrates the user 110 performing hand gesture 140 while gazing at object 150 at gaze input 390. In some embodiments, the user 110 gazes around the portion of the object 150 they intend to select, and the multiple gaze inputs 390-A, 390-B, 390-C, 390-D comprise the gaze of the user 110 surrounding the object 150. In some embodiments, the multiple gaze inputs 390-A, 390-B, 390-C, 390-D demonstrate the intended trajectory, shape, and size of the selection gesture 160. In some embodiments, in accordance with the multiple gaze inputs 390-A, 390-B, 390-C, 390-D surrounding the object 150, the multiple gaze inputs 390-A, 390-B, 390-C, 390-D are weighted higher than the gesture size and gesture shape of the selection gesture 160 when determining the portion of object 150 that the user 110 intends to select. In some embodiments, the weighted inputs are input into a machine-learning model and the selection is determined by the machine-learning model. In some embodiments, the machine-learning model is the AI assistant. In some embodiments, the AI assistant is prompted to input the weighted inputs into the machine-learning model and to interpret the output of the machine-learning model to determine the selection. In some embodiments, the multiple gaze inputs 390-A, 390-B, 390-C, 390-D are selected randomly from the gaze of the user 110 as the user 110 performs the selection gesture 160. In some embodiments, the multiple gaze inputs 390-A, 390-B, 390-C, 390-D are sampled at the threshold amount of time as the user 110 performs the selection gesture 160.

In some embodiments, a speed at which the user 110 performs the selection gesture 160 indicates whether to weigh the gesture size and gesture shape or the multiple gaze inputs 390-A, 390-B, 390-C, 390-D higher when determining the selection. For example, when the user 110 performs selection gesture 160 around a portion of the object 150 (e.g., the tail of a dog) over a threshold period of time (e.g., five seconds) and the multiple gaze inputs 390-A, 390-B, 390-C, 390-D surround the portion of the object 150, but the gesture size and gesture shape capture a larger portion of the object 150 than the portion of the object 150 gazed at by the user 110 when multiple gaze inputs 390-A, 390-B, 390-C, 390-D are captured, the selection will weigh the multiple gaze inputs 390-A, 390-B, 390-C, 390-D over the gesture size and gesture shape.

In some embodiments, when multiple objects are nested within one another (e.g., a pen inside a cup or a figure on a shelf), the gesture size and gesture shape may be used to determine whether the user 110 intends to select the larger object, the smaller object, or both objects. In some embodiments, a smaller gesture size indicates an intent to select the smaller object, while a larger gesture size may indicate an intent to select the larger object or both objects. The gaze data further refines this determination by indicating which specific portion of the nested objects the user 110 intends to select. For example, the user 110 performs selection gesture 160 with a narrow shape, indicating that they intend to select a pen in a cup while gazing at the pen, and not a portion of the cup and/or both the cup and pen while performing the selection gesture 160.

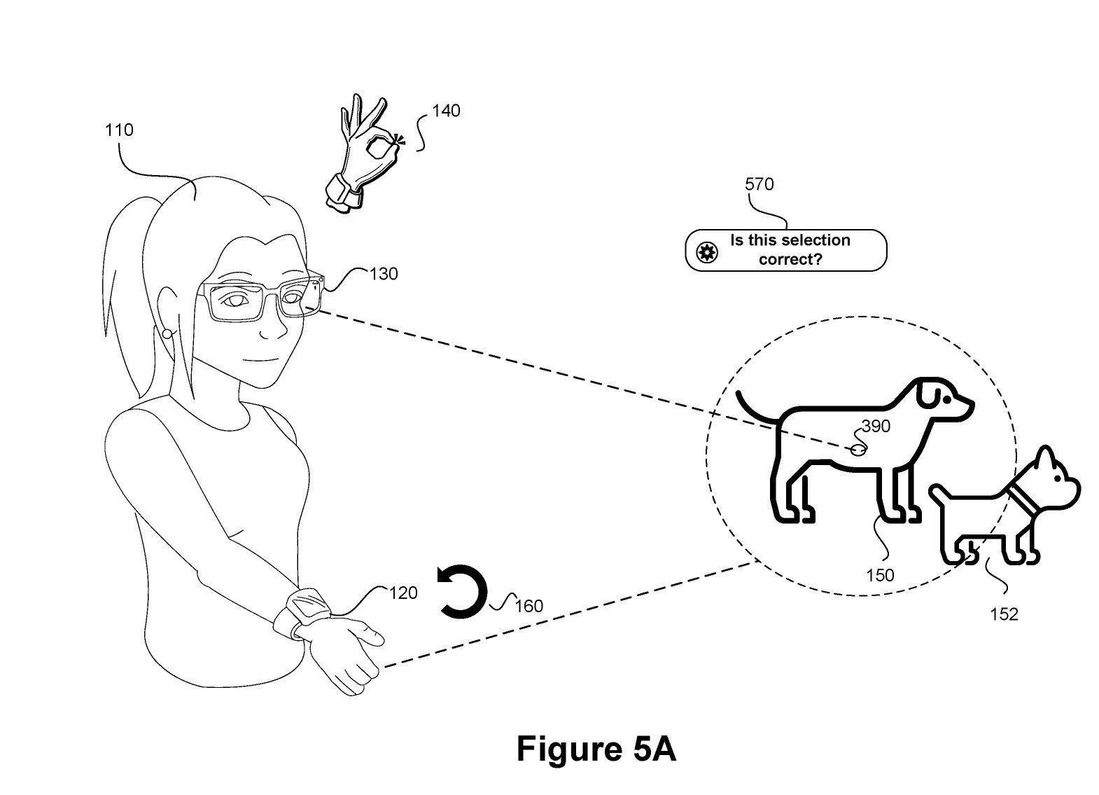

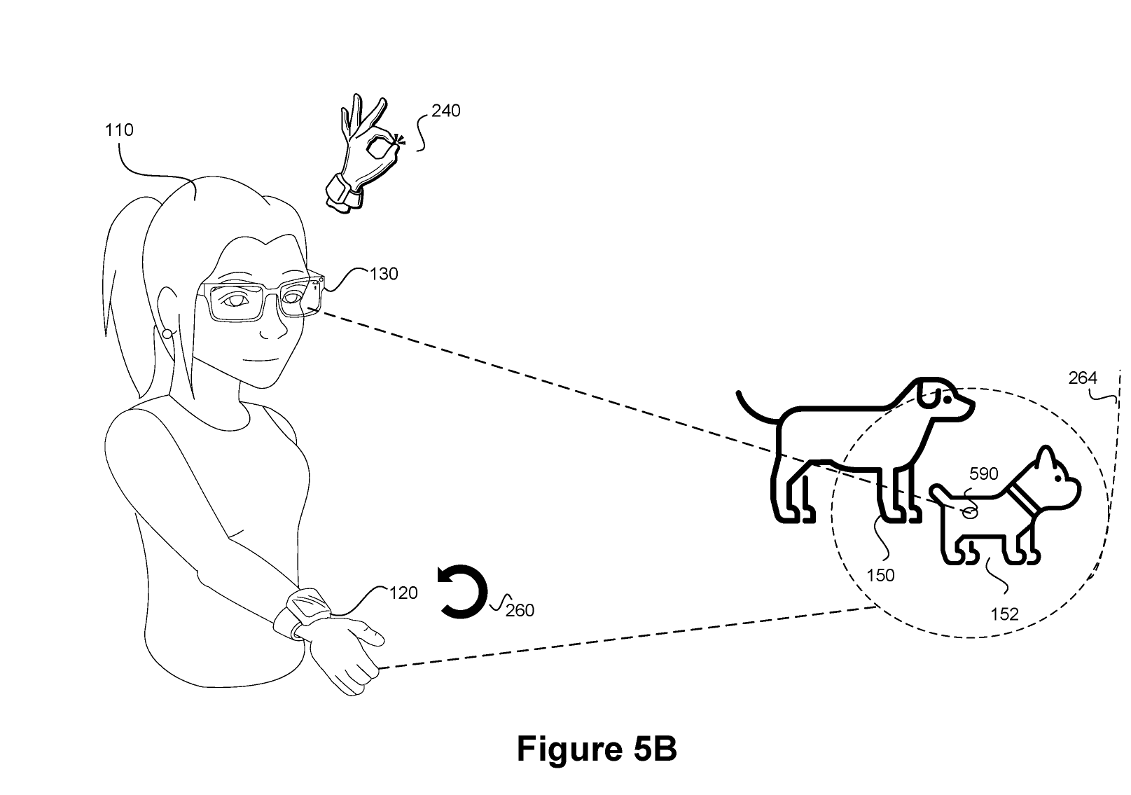

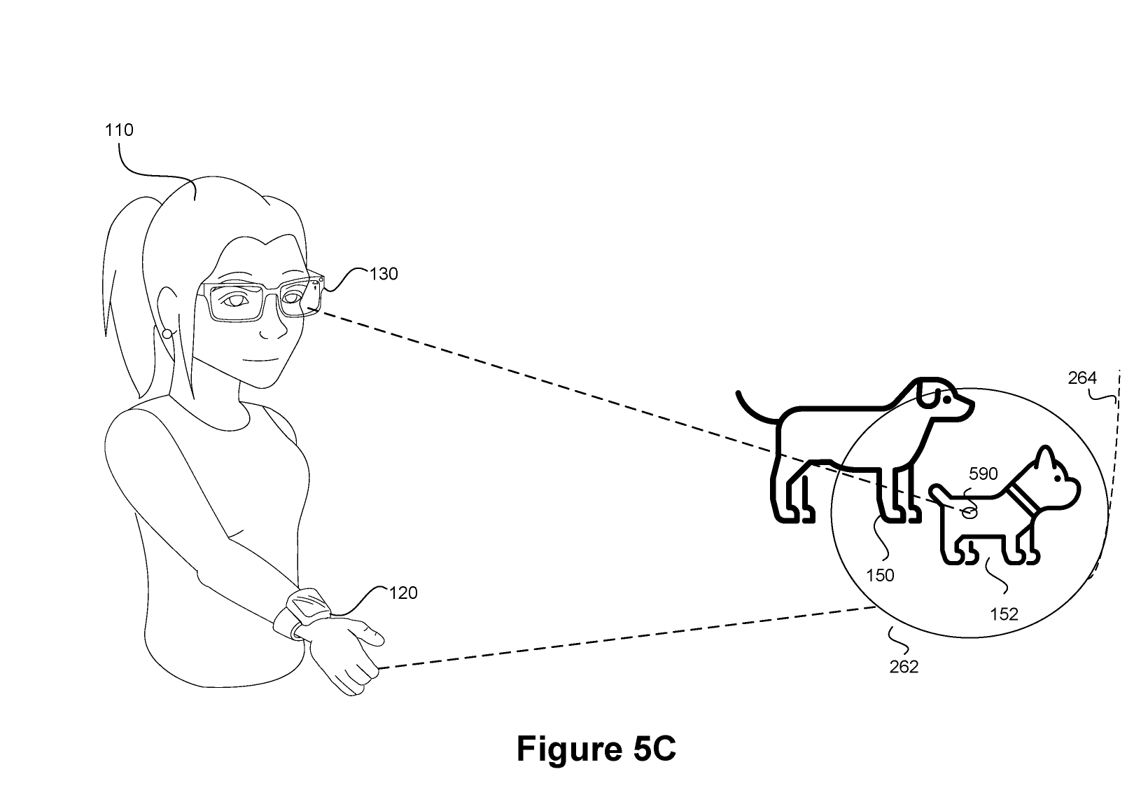

FIGS. 5A–5C illustrate invocation of an object selection procedure, in accordance with some embodiments. FIG. 5A illustrates the user 110 performing hand gesture 140 while gazing at object 150 at gaze input 390. In some embodiments, the selection gesture 160 is centered around gaze input 390 and is large enough to capture a portion of both object 150 and object 152. In some embodiments, the gaze input 390 is analyzed with the selection input 160 to determine that the user 110 intends to select a portion of object 150 and not a portion of object 152. In some embodiments, the gaze of the user 110 before performance of hand gesture 140 is analyzed to determine whether the user 110 intends to select a portion of the object 150 and a portion of the object 152. In some embodiments, a confirmation indication 570 (e.g., “Is this selection correct?”) is presented at (i) one or more speakers of the head-wearable device 130, the wrist-wearable device 120, and/or the other device, and/or (ii) one or more displays of the wrist-wearable device 120 and/or the other device. In some embodiments, the user 110 provides a response to the confirmation indication 570 indicating that the selection is correct. In some embodiments, the user 110 provides a different response to the confirmation indication 570 indicating that the selection is incorrect. In some embodiments, the user 110 performs hand gesture 140 in response to the confirmation indication 570 to restart the object selection procedure, and the selection is automatically discarded.

FIG. 5B illustrates the user 110 performing the second hand gesture 240 while gazing at object 152 at second gaze input 590, in accordance with some embodiments. In some embodiments, the second selection gesture 260 is centered around the second gaze input 590. In some embodiments, the second selection gesture 260 includes a tail 264. In some embodiments, the tail 264 is disregarded when determination of the selection of at least a portion of the object 152 occurs. In some embodiments, the tail 264 comprises any portion of the second selection input 260 that overlaps an earlier portion of the selection input 260 and/or that does not encapsulate the object 152. In some embodiments, the gaze input 590 is analyzed with the second selection input 260 to determine that the user 110 intends to select a portion of object 152 and not a portion of object 15. In some embodiments, the gaze of the user 110 before performance of hand gesture 240 is analyzed to determine whether the user 110 intends to select a portion of the object 152 and a portion of the object 150. In some embodiments, an AI assistant determines what portion of the second selection gesture 260 is the tail 264. In some embodiments, the AI assistant analyzes previous selections by the user 110 to determine what portion of the second selection gesture 260 is the tail 264.

In some embodiments, object 150 and object 152 are overlapped, stacked, or partially occluded with each other within the field of view of the user 110. The gaze data in conjunction with the image data is analyzed to determine which of the overlapping objects the user 110 intends to select. For example, if object 150 partially occludes object 152, and the gaze data indicates that the user is gazing at a portion of object 152 that is visible behind object 150, a determination that the user 110 intends to select object 152 and not object 150 occurs and no portion of object 150 is selected.

In some embodiments, the gaze data is analyzed over a period of time preceding the hand gesture 140 to determine the intent of the user 110. For example, if the user 110 gazed at object 150 for a longer duration than object 152 before performing the hand gesture 140, gaze data directed at object 150 is weighted higher than gaze data directed at object 152 when determining the intended selection, even if the selection gesture 160 encompasses both object 150 and object 152.

FIG. 5C illustrates the user 110 having completed the second selection gesture 260, in accordance with some embodiments. In some embodiments, a finalized selection 262 is separated from the tail 264 during the determination of the selection of at least the portion of the object 152. In some embodiments, the finalized selection 262 is determined by an AI assistant. In some embodiments, an indication of the finalized selection 262 is presented to the user 110 at one or more displays of the wrist-wearable device 120 and/or the other device. In some embodiments, the tail 264 is presented to the user 110 and is denoted as not part of the finalized selection 262 (e.g., the finalized selection 262 is indicated as a solid line, and the tail 264 is indicated as a dotted line). In some embodiments, the tail 264 is not presented to the user 110, and only the finalized selection 262 is presented to the user 110.

### Recognizing Objects from Past User Gaze Inputs Received at Wearable Devices

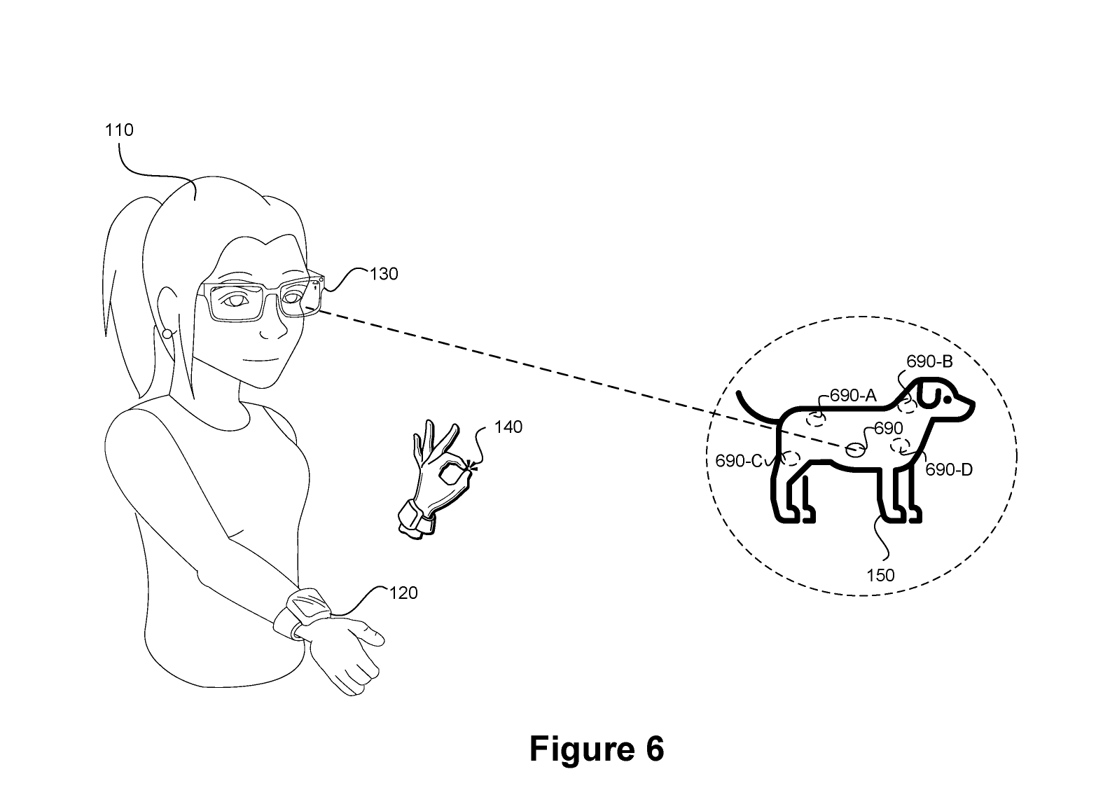

FIG. 6 illustrates invocation of an object selection procedure, in accordance with some embodiments. In some embodiments, the user 110 performs hand gesture 140 while gazing at gaze input 690 corresponding to a portion of the object 150. In some embodiments, the intent of the user 110 to select a portion of the object 150 is based on previous gaze inputs 690-A, 690-B, 690-C, and/or 690-D. In some embodiments, the previous gaze inputs 690-A, 690-B, 690-C, 690-D are captured by the one or more cameras of the head-wearable device 130 at a threshold amount of time (e.g., every half second) before hand gesture 140 is performed. In some embodiments, the previous gaze inputs 690-A, 690-B, 690-C, 690-D are sampled at random intervals within a certain amount of time (e.g., four seconds) before the user 110 performs hand gesture 140. In some embodiments, the selection of a portion of the object 150 is based on gaze input 690 and the previous gaze inputs 690-A, 690-B, 690-C, 690-D.

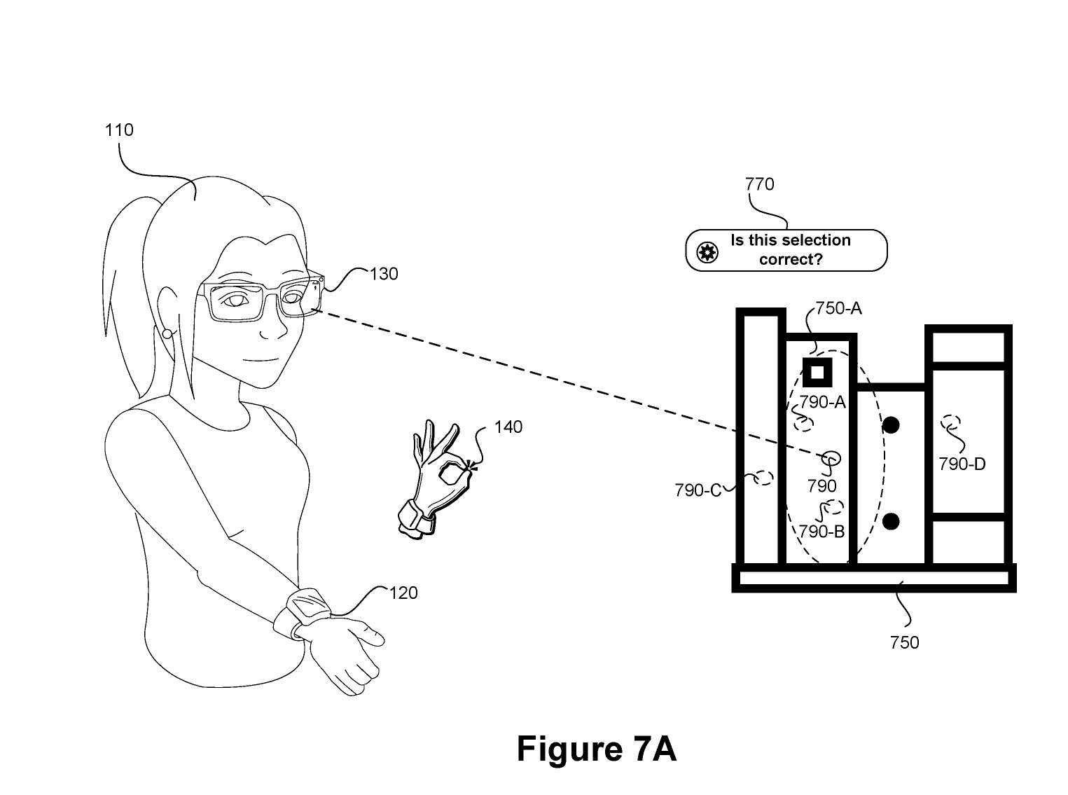

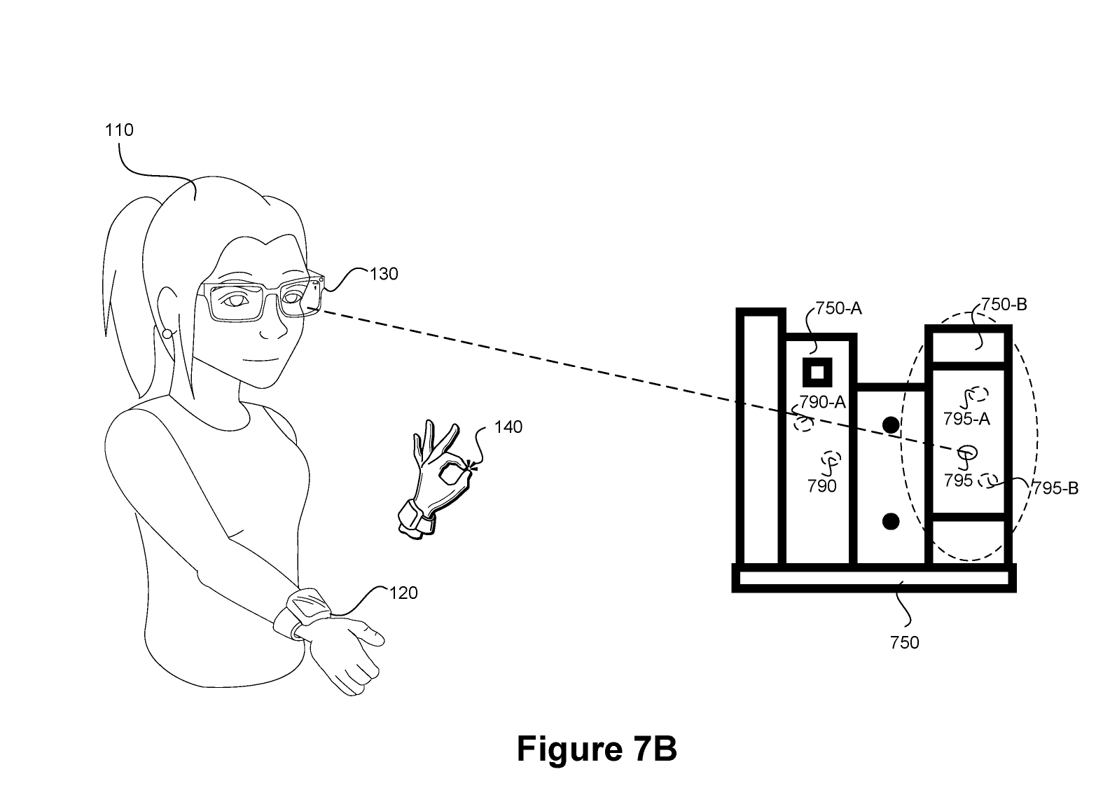

FIGS. 7A and 7B illustrate invocation of an object selection procedure, in accordance with some embodiments. FIG. 7A illustrates the user 110 performing hand gesture 140 while gazing at object 750 (e.g., a bookcase) at gaze input 790. In some embodiments, the object 750 comprises one or more portions (e.g., one or more individual books), including object 750-A (e.g., an individual book). In some embodiments, the intent of the user 110 is to select object 750-A, and not all of object 750 and/or a different portion of object 750 besides object 750-A is based on previous gaze inputs 790-A, 790-B, 790-C, and/or 790-D. In some embodiments, the user 110 gazes at different portions of the object 750 before performing hand gesture 140. In some embodiments, the intent of the user 110 to select object 750-A is based on the gaze input 790, which is captured when the user 110 performs the hand gesture 140. In some embodiments, the intent of the user 110 to select object 750-A is based on the gaze input 790 and the previous gaze inputs 790-A, 790-B, 790-C, 790-D, wherein gaze inputs closer in time to gaze input 790 are weighted higher than gaze inputs farther in time from gaze input 790. In some embodiments, the weighted inputs are input into a machine-learning model and the selection is based on an output of the machine-learning model. In some embodiments, the selection is based on a cognitive inference by the AI assistant, the AI assistant monitoring attentional state detection of the user 110. For example, the user 110 stares at bookcase 750, and specifically stares at the right-most book (e.g., previous gaze input 790-D), then the left-most book (e.g., previous gaze input 790-C), and then the middle-left book 750-A (e.g., previous gaze inputs 790-A and 790-B) before performing hand gesture 140 while continuing to gaze at the middle-left book 750-A. In some embodiments, the determination that the user 110 intends to select object 750-A is based on both the most recent previous gaze inputs before the user 110 performs hand gesture 140, and how many previous gaze inputs are focused on a specific object compared to other objects before the user 110 performs hand gesture 140. In some embodiments, the user 110 is presented with a selection indication 770 (e.g., “Is this selection correct?”) requesting that the user 110 intended to select object 750-A. In some embodiments, the selection indication 770 comprises an audio output at one or more speakers of the head-wearable device 130, wrist-wearable device 120, and/or the other device, a representation of the selection and/or of object 750-A at one or more displays of the wrist-wearable device 120, the head-wearable device 130, and/or the other device, or a combination of the audio output and the representation.

FIG. 7B illustrates the user 110 performing hand gesture 140 while gazing at object 750-B, in accordance with some embodiments. In some embodiments, the user 110 previously gazed at object 750-A at previous points in time, indicated by gaze inputs 790 and 790-A. The user 110 then gazed at object 750-B at other previous points in time, indicated by gaze inputs 795-A and 795-B, and gazed at object 750-B when performing hand gesture 140 at gaze input 795. In some embodiments, because gaze input 795 occurred when the user 110 performed the hand gesture 140, and gaze inputs 790 and 790-A occurred before the user 110 performed the hand gesture 140, gaze input 795 is weighted higher than gaze inputs 790 and 790-A when determining whether the user 110 intended to select object 750-B or object 750-A. In some embodiments, because the user 110 performed gaze inputs 795-A and 795-B before performing the hand gesture 140, which comprise the user 110 gazing at object 750-B and not other portions of object 750, gaze inputs 795-A and 795-B are weighted higher than gaze inputs 790 and 790-A when determining whether the user 110 intended to select object 750-B or object 750. In some embodiments, if the user 110 immediately performs hand gesture 140 after an indication of a selection was presented, previous gaze inputs (e.g., gaze inputs 790 and 790-A) are disregarded when determining the intent of the user 110 to select a portion of the object 750.

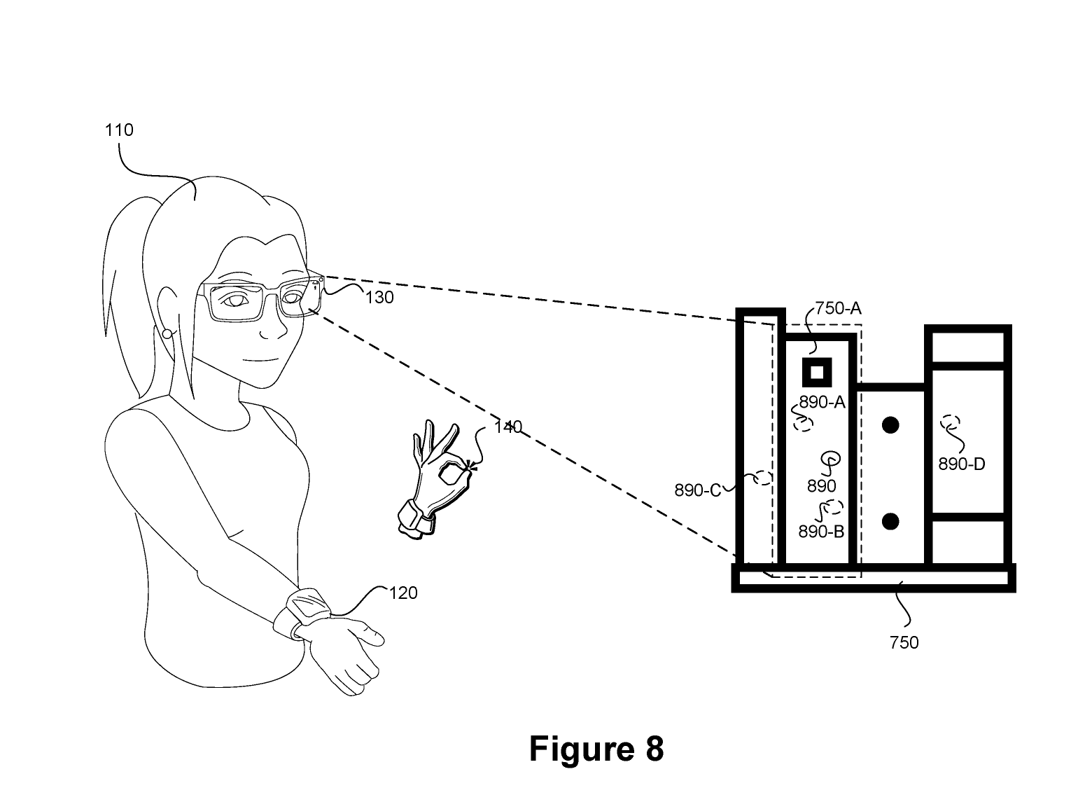

FIG. 8 illustrates invocation of an object selection procedure, in accordance with some embodiments. In some embodiments, the user 110 performs hand gesture 140 while gazing at a portion of object 750 at gaze input 890. In some embodiments, a plurality of previous gaze inputs 890-A, 890-B, 890-C, and 890-D are analyzed to determine which portion of object 750 that the user 110 intends to select. In some embodiments, the plurality of previous gaze inputs 890-A, 890-B, 890-C, 890-D are averaged with gaze input 890 to determine what portion of object 750 the user 110 intends to select. In some embodiments, the plurality of previous gaze inputs 890-A, 890-B, 890-C, 890-D that are closest in time to the user 110 performing hand gesture 140 are weighted higher than the plurality of previous gaze inputs 890-A, 890-B, 890-C, 890-D that are furthest in time from the user 110 performing hand gesture 140 and are disregarded when determining what portion of object 750 the user 110 intends to select. In some embodiments, the plurality of previous gaze inputs 890-A, 890-B, 890-C, 890-D are previous gaze inputs captured within a certain amount of time before the user 110 performs hand gesture 140 (e.g., within two seconds). In some embodiments, the determination of the portion of object 750 that the user 110 intends to select is based on a simple majority of the plurality of previous gaze inputs 890-A, 890-B, 890-C, 890-D and gaze input 890. In some embodiments, an indication of the selection is presented to the user 110. In some embodiments, the user 110 provides a confirmation that the selection is correct. In some embodiments, if the user 110 provides input corresponding to the selection being incorrect (e.g., a voice input, a selection on a user interface presented at a display of the wrist-wearable device 120, a hand gesture, or any other suitable input modality), the selection can be discarded or re-determined. In some embodiments, if the user 110 provides the hand gesture 140 in response to the indication of the selection, the selection is re-determined. In some embodiments, the re-determination is based on the gaze input 890 and the plurality of previous gaze inputs 890-A, 890-B, 890-C, 890-D. In some embodiments, the re-determination is based on new gaze inputs.

### Example Diagrams for Performing an Object Selection Procedure

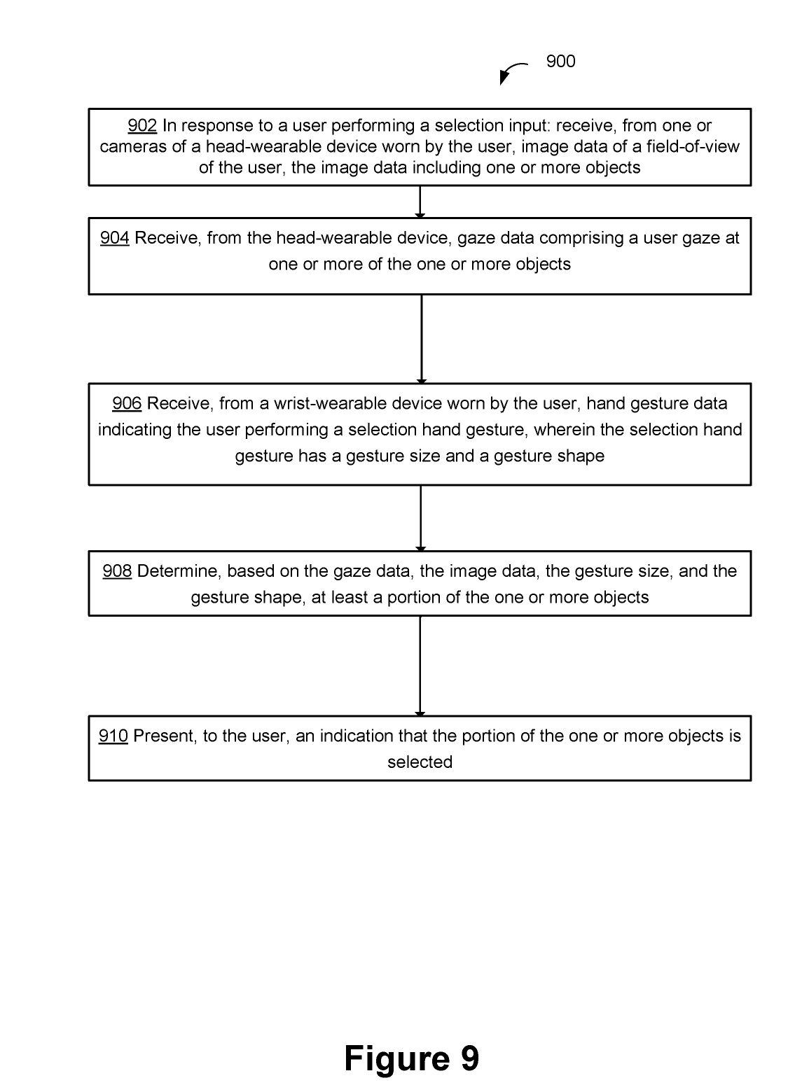

FIG. 9 illustrates a flow diagram of a method of invocation of an object selection procedure, in accordance with some embodiments. Operations (e.g., steps) of the method 900 can be performed by one or more processors (e.g., central processing unit and/or MCU) of a system (e.g., a head-wearable device 130 and wrist-wearable device 120 worn by a user 110). At least some of the operations shown in FIG. 9 correspond to instructions stored in a computer memory or computer-readable storage medium (e.g., storage, RAM, and/or memory, such as memory of a head-wearable device 1128 or a wrist-wearable device 1126). Operations of the method 900 can be performed by a single device alone or in conjunction with one or more processors and/or hardware components of another communicatively coupled device (e.g., a handheld intermediary processing device 1142, head-wearable device 1128, and/or other devices described below in reference to FIGS. 11A–11C) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device, but should not be construed as limiting the performance of the operation to the particular device in all embodiments.

A1 FIG. 9 shows a flow chart of a method 900 of invocation of an object selection procedure, in accordance with some embodiments. The method 900 occurs at one of a head-wearable device and a wrist-wearable device with one or more microphones, cameras, and/or displays. In some embodiments, the method 900 includes, in response to a user performing a selection input: receiving (902), from one or more cameras of a head-wearable device worn by the user, image data of a field-of-view of the user, the image data including one or more objects, receiving (904), from the head-wearable device, gaze data comprising a user gaze at one or more of the one or more objects, receiving (906), from a wrist-wearable device worn by the user, hand gesture data indicating the user performing a selection hand gesture. The selection hand gesture has a gesture size and a gesture shape. The method 900 further includes determining (908), based on the gaze data, the image data, the gesture size, and the gesture shape, at least a portion of the one or more objects, and presenting (910), to the user, an indication that the portion of the one or more objects is selected. For example, as shown in at least FIGS. 1A and 1B, a user (110) wearing a head-wearable device (130) and a wrist-wearable device (120) performs a hand gesture (140) while an object (150) is within a field of view of the user (110). The user (110) performs a selection gesture (160) and selects at least a portion of the object (150), and the user (110) is presented with a selection indication (170) (e.g., “You’ve selected a dog”) presented at one or both of the head-wearable device (130) and the wrist-wearable device (120).

A2 In some embodiments of A1, in response to the user performing a second selection input, receive, from the one or more cameras of the head-wearable device, second image data, distinct from the image data, of a second field-of-view of the user, the second image data including one or more other objects; receive, from the head-wearable device, second gaze data, distinct from the gaze data, comprising a user gaze at one or more of the one or more other objects; receive, from the wrist-wearable device worn by the user, second hand gesture data indicating the user performing a second selection hand gesture, wherein the second selection hand gesture has a second gesture size and a second gesture shape; determine, based on the second gaze data, the second image data, the second gesture size, and the second gesture shape, at least a portion of the one or more other objects; and present, to the user, a second indication that the portion of the one or more other objects is selected. For example, as shown in at least FIGS. 2C and 2D, a user (110) wearing a head-wearable device (130) and a wrist-wearable device (120) performs a hand gesture (240) while object (150) and object (152) are within a field of view of the user (110). The user (110) performs a selection gesture (260) and selects at least a portion of the object (152), and the user (110) is presented with a selection indication (270) (e.g., “You’ve selected the terrier”) presented at one or both of the head-wearable device (130) and the wrist-wearable device (120).

A3 In some embodiments of any of A1-A2, before presenting the indication that the portion of the one or more objects is selected, and in response to the user performing another selection input: receive, from the head-wearable device, other gaze data comprising a user gaze at another one or more objects of the one or more objects; receive, from the wrist-wearable device worn by the user, other hand gesture data indicating the user performing another selection hand gesture, wherein the other selection hand gesture has another gesture size and another gesture shape; determine, based on the other gaze data, the image data, the other gesture size, and the other gesture shape, at least a portion of the other one or more objects; and present, to the user, the indication that the portion of the one or more objects is selected and another indication that the portion of the other one or more objects is selected. For example, as shown in at least FIGS. 2A-2D, a user (110) wearing a head-wearable device (130) and a wrist-wearable device (120) performs a hand gesture (140) while object (150) and object (152) are within a field of view of the user (110). The user (110) performs a selection gesture (160) and selects at least a portion of the object (150). The user performs a hand gesture (240) while the object (150) and the object (152) are within the field of view of the user (110). The user (110) performs a selection gesture (260) and selects at least a portion of the object (152), and the user (110) is presented with selection indication (170) (e.g., “You’ve selected the golden retriever”) and selection indication (270) (e.g., “You’ve selected the terrier”) presented at one or both of the head-wearable device (130) and the wrist-wearable device (120).

A4 In some embodiments of any of A1-A3, the method 900 further includes identifying, based on the gaze data, an anchor coordinate based on a time-series of previous gaze data, wherein the selection hand gesture is centered around the anchor coordinate to identify the portion of the one or more objects. For example, as shown in at least FIG. 3, a user (110) wearing a head-wearable device (130) and a wrist-wearable device (120) performs a hand gesture (140) while an object (150) is within a field of view of the user (110). The user (110) performs a selection gesture (160) and selects at least a portion of the object (150), the selection centered around gaze input (390).

A5 In some embodiments of any of A1-A4, after presenting the indication to the user, generate, using a large language model, a summary comprising information about the portion of the one or more objects. For example, as shown in at least FIGS. 1A and 1B, a user (110) wearing a head-wearable device (130) and a wrist-wearable device (120) performs a hand gesture (140) while an object (150) is within a field of view of the user (110). The user (110) performs a selection gesture (160) and selects at least a portion of the object (150), and the user (110) is presented with a selection indication (170) generated by a large language model (e.g., an artificially intelligent assistant) (e.g., “You’ve selected a dog”) presented at one or both of the head-wearable device (130) and the wrist-wearable device (120).

A6 In some embodiments of any of A1-A5, the hand gesture data is received over a period of time; the gaze data is received over the period of time, the gaze data comprising a gaze size and a gaze shape; the portion of the one or more objects is further determined by the gaze size and the gaze shape; and in accordance with the period of time exceeding a threshold time, the determination of the portion of the one or more objects is weighted towards the gaze size and the gaze shape rather than the gesture size and the gesture shape. For example, as shown in at least FIG. 4A, a user (110) wearing a head-wearable device (130) and a wrist-wearable device (120) performs a hand gesture (140) while an object (150) is within a field of view of the user (110) and a gaze input (390) is captured. The user (110) performs a selection gesture (160) and selects at least a portion of the object (150). While the user (110) performs the selection gesture (160), a plurality of gaze inputs (390-A) (390-B) (390-C) (390-D) are captured, and the portion of the object (150) is selected based on the selection gesture (160), the gaze input (390), and the plurality of gaze inputs (390-A) (390-B) (390-C) (390-D).

A7 In some embodiments of any of A1-A6, the selection input is a pinch gesture; the hand gesture data comprises a continuous gesture while the pinch gesture is held; the hand gesture data is tracked by an inertial measurement unit that uses relative movement in relation to a beginning of the continuous gesture; the hand gesture data ceases to be tracked when the pinch gesture is released; and the determination is further based on an average position of the gaze data. For example, as shown in at least FIG. 4B, a user (110) wearing a head-wearable device (130) and a wrist-wearable device (120) performs a hand gesture (140) while an object (150) is within a field of view of the user (110) and a gaze input (390) is captured. The user (110) performs a selection gesture (160) while maintaining the hand gesture (140) and selects at least a portion of the object (150). While the user (110) performs the selection gesture (160), a plurality of gaze inputs (390-A) (390-B) (390-C) (390-D) are captured, and the portion of the object (150) is selected based on the selection gesture (160), the gaze input (390), and an average position of the plurality of gaze inputs (390-A) (390-B) (390-C) (390-D).

A8 In some embodiments of any of A1-A7, the indication prompts the user to confirm whether the portion of the one or more objects was correctly selected. For example, as shown in at least FIG. 5A, a user (110) wearing a head-wearable device (130) and a wrist-wearable device (120) performs a hand gesture (140) while an object (150) is within a field of view of the user (110). The user (110) performs a selection gesture (160) and selects at least a portion of the object (150), and the user (110) is presented with a selection indication (570) (e.g., “Is this selection correct?”) presented at one or both of the head-wearable device (130) and the wrist-wearable device (120).

B1 In accordance with some embodiments, a system that includes a wrist wearable device (or a plurality of wrist-wearable devices) and a pair of augmented-reality glasses, and the system is configured to perform operations corresponding to any of A1-A8.

C1 In accordance with some embodiments, a non-transitory computer readable storage medium including instructions that, when executed by a computing device in communication with a pair of augmented-reality glasses, cause the computer device to perform operations corresponding to any of A1- A8.

D1 In accordance with some embodiments, a method of operating a pair of augmented-reality glasses, including operations that correspond to any of A1- A8.

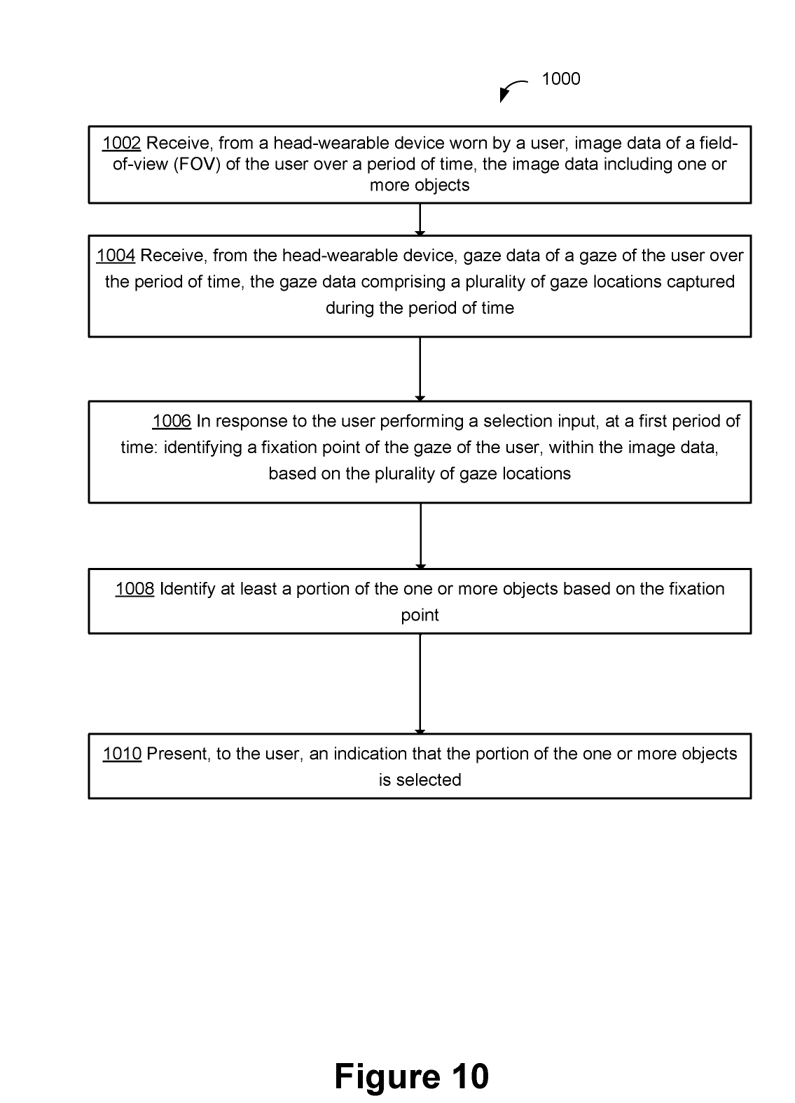

FIG. 10 illustrates a flow diagram of a method of invocation of an object selection procedure, in accordance with some embodiments. Operations (e.g., steps) of the method 1000 can be performed by one or more processors (e.g., central processing unit and/or MCU) of a system (e.g., a head-wearable device 130 and wrist-wearable device 120 worn by a user 110). At least some of the operations shown in FIG. 10 correspond to instructions stored in a computer memory or computer-readable storage medium (e.g., storage, RAM, and/or memory) (e.g., a head-wearable device 130 and wrist-wearable device 120 worn by a user 110). Operations of the method 1000 can be performed by a single device alone or in conjunction with one or more processors and/or hardware components of another communicatively coupled device (e.g., a handheld intermediary processing device 1142, head-wearable device 1128, and/or other devices described below in reference to FIGS. 11A-11C) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device, but should not be construed as limiting the performance of the operation to the particular device in all embodiments.

E1 FIG. 10 shows a flow chart of a method 1000 of invocation of an object selection procedure, in accordance with some embodiments. The method 1000 occurs at one of a head-wearable device and a wrist-wearable device with one or more microphones, cameras, and/or displays. In some embodiments, the method 1000 includes, in response to a user performing a selection input: receiving (1002), from a head-wearable device worn by a user, image data of a field-of-view (FOV) of the user over a period of time, the image data including one or more objects, receiving (1004), from the head-wearable device, gaze data of a gaze of the user over the period of time, the gaze data comprising a plurality of gaze locations captured during the period of time. The method 1000 further includes, in response to the user performing a selection input, at a first period of time: identifying (1006) a fixation point of the gaze of the user, within the image data, based on the plurality of gaze locations, identifying (1008) at least a portion of the one or more objects based on the fixation point, and presenting (1010), to the user, an indication that the portion of the one or more objects is selected. For example, as shown in at least FIG. 6, a user (110) wearing a head-wearable device (130) and a wrist-wearable device (120) performs a hand gesture (140) while an object (150) is within a field of view of the user (110) and a gaze input (690) is captured. When the user (110) performs the hand gesture (140), a plurality of gaze inputs (690-A) (690-B) (690-C) (690-D) captured from a period of time before the user (110) performed the hand gesture (140) are analyzed with gaze input (690) to determine a portion of the object (150) to select.

E2 In some embodiments of E1, the method 1000 further includes receiving, from the head-wearable device, second image data of a second FOV of the user over a second period of time, the second image data distinct from the image data and the second period of time distinct from the period of time, the second image data including one or more other objects; receiving, from the head-wearable device, second gaze data of a gaze of the user over the second period of time, the second gaze data comprising a second plurality of gaze locations captured during the second period of time; in response to the user performing a second selection input, at a third period of time: identifying a second fixation point of the gaze of the user, within the second image data, based on the second plurality of gaze locations; identifying at least a portion of the one or more other objects based on the second fixation point; and presenting, to the user, a second indication that the portion of the one or more other objects is selected. For example, as shown in at least FIG. 6, a user (110) wearing a head-wearable device (130) and a wrist-wearable device (120) performs a hand gesture (140) while an object (150) is within a field of view of the user (110) and a gaze input (690) is captured. When the user (110) performs the hand gesture (140), a plurality of gaze inputs (690-A) (690-B) (690-C) (690-D) are captured from a period of time before the user (110) performed the hand gesture (140) and are analyzed with gaze input (690) to determine a portion of the object (150) to select.

E3 In some embodiments of any of E1-E2, the method 1000 further includes receiving, from the head-wearable device worn by the user, additional image data of an additional FOV of the user over an additional period of time, the additional image data distinct from the image data and the additional period of time distinct from the period of time, the additional image data including one or more additional objects; receiving, from the head-wearable device, additional gaze data of a gaze of the user over the additional period of time, the additional gaze data comprising an additional plurality of gaze locations captured during the additional period of time; in response to the user performing an additional selection input, at a fourth period of time: identifying a plurality of additional fixation points of the gaze of the user, within the additional image data, based on the additional plurality of gaze locations; identifying at least a portion of the one or more additional objects based on the plurality of additional fixation points; and presenting, to the user, an additional indication that the portion of the one or more additional objects is selected. For example, as shown in at least FIGS. 7A and 7B, a user (110) wearing a head-wearable device (130) and a wrist-wearable device (120) performs a hand gesture (140) while an object (750) is within a field of view of the user (110) and a gaze input (790) is captured. When the user (110) performs the hand gesture (140), a plurality of gaze inputs (790-A) (790-B) (790-C) (790-D) are captured from a period of time before the user (110) performed the hand gesture (140) are analyzed with gaze input (790) to determine a portion of the object (750-A) to select, and an indication of the selection (570) is presented to the user (110). The user (110) performs the hand gesture (140) again while the object (750) is within the field of view of the user (110) and another gaze input (795) is captured. When the user (110) performs the hand gesture (140) again, another plurality of gaze inputs (795-A) (795-B) are captured from a period of time before the user (110) performed the hand gesture (140) again and are analyzed with the other gaze input (795) to determine another portion of the object (750-B) to select.

E4 In some embodiments of any of E1-E3, the identification of the portion of the one or more objects comprises: generating a satisfaction score using a machine learning model and comparing the satisfaction score to a threshold score; and the machine learning model is stored on one or more of (i) the head-wearable device and (ii) an intermediary processing device communicatively coupled to the head-wearable device.

E5 In some embodiments of any of E1-E4, after presenting the indication to the user, generate, using a large language model, a summary comprising information about the portion of the one or more objects.

E6 In some embodiments of any of E1-E5, the indication prompts the user to confirm whether the portion of the object was correctly identified. For example, as shown in at least FIG. 7A, a user (110) wearing a head-wearable device (130) and a wrist-wearable device (120) performs a hand gesture (140) while an object (750) is within a field of view of the user (110) and a gaze input (790) is captured. When the user (110) performs the hand gesture (140), a plurality of gaze inputs (790-A) (790-B) (790-C) (790-D) are captured from a period of time before the user (110) performed the hand gesture (140) are analyzed with gaze input (790) to determine a portion of the object (750-A) to select, and an indication of the selection (770) (e.g., “Is this selection correct?”) is presented to the user (110).

E7 In some embodiments of any of E1-E6, the selection input is a pinch gesture, the period of time is more than 1 second but less than 2 seconds, the plurality of gaze locations comprises 5 gaze points over the period of time, and the identification of the fixation point is based on an average position of the plurality of gaze locations.

E8 In some embodiments of any of E1-E7, a respective weight of a plurality of weights is assigned to each of the plurality of gaze locations, wherein larger weights are assigned to gaze locations closer in time to the first period of time, and the identification of the fixation point is based on the respective weights of the plurality of gaze locations. For example, as shown in at least FIG. 8, a user (110) wearing a head-wearable device (130) and a wrist-wearable device (120) performs a hand gesture (140) while an object (750) is within a field of view of the user (110) and a gaze input (890) is captured. When the user (110) performs the hand gesture (140), a plurality of gaze inputs (890-A) (890-B) (890-C) (890-D) are captured and weighted based on how much earlier they were captured from a period of time when the user (110) performed the hand gesture (140), and the plurality of gaze inputs (890-A) (890-B) (890-C) (890-D) are analyzed with gaze input (890) to determine a portion of the object (750-A) to select.

F1 In accordance with some embodiments, a system that includes a wrist wearable device (or a plurality of wrist-wearable devices) and a pair of augmented-reality glasses, and the system is configured to perform operations corresponding to any of E1-E8.

G1 In accordance with some embodiments, a non-transitory computer readable storage medium including instructions that, when executed by a computing device in communication with a pair of augmented-reality glasses, cause the computer device to perform operations corresponding to any of E1- E8.

H1 In accordance with some embodiments, a method of operating a pair of augmented-reality glasses, including operations that correspond to any of E1- E8.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

FIGS. 11A, 11B, 11C-1, and 11C-2, illustrate example XR systems that include AR and MR systems, in accordance with some embodiments. FIG. 11A shows a first XR system 1100a and first example user interactions using a wrist-wearable device 1126, a head-wearable device (e.g., AR device 1128), and/or a HIPD 1142. FIG. 11B shows a second XR system 1100b and second example user interactions using a wrist-wearable device 1126, AR device 1128, and/or an HIPD 1142. FIGS. 11C-1 and 11C-2 show a third MR system 1100c and third example user interactions using a wrist-wearable device 1126, a head-wearable device (e.g., an MR device such as a VR device), and/or an HIPD 1142. As the skilled artisan will appreciate upon reading the descriptions provided herein, the above-example AR and MR systems (described in detail below) can perform various functions and/or operations.

The wrist-wearable device 1126, the head-wearable devices, and/or the HIPD 1142 can communicatively couple via a network 1125 (e.g., cellular, near field, Wi-Fi, personal area network, wireless LAN). Additionally, the wrist-wearable device 1126, the head-wearable device, and/or the HIPD 1142 can also communicatively couple with one or more servers 1130, computers 1140 (e.g., laptops, computers), mobile devices 1150 (e.g., smartphones, tablets), and/or other electronic devices via the network 1125 (e.g., cellular, near field, Wi-Fi, personal area network, wireless LAN). Similarly, a smart textile-based garment, when used, can also communicatively couple with the wrist-wearable device 1126, the head-wearable device(s), the HIPD 1142, the one or more servers 1130, the computers 1140, the mobile devices 1150, and/or other electronic devices via the network 1125 to provide inputs.

Turning to FIG. 11A, a user 1102 is shown wearing the wrist-wearable device 1126 and the AR device 1128 and having the HIPD 1142 on their desk. The wrist-wearable device 1126, the AR device 1128, and the HIPD 1142 facilitate user interaction with an AR environment. In particular, as shown by the first AR system 1100a, the wrist-wearable device 1126, the AR device 1128, and/or the HIPD 1142 cause presentation of one or more avatars 1104, digital representations of contacts 1106, and virtual objects 1108. As discussed below, the user 1102 can interact with the one or more avatars 1104, digital representations of the contacts 1106, and virtual objects 1108 via the wrist-wearable device 1126, the AR device 1128, and/or the HIPD 1142. In addition, the user 1102 is also able to directly view physical objects in the environment, such as a physical table 1129, through transparent lens(es) and waveguide(s) of the AR device 1128. Alternatively, an MR device could be used in place of the AR device 1128 and a similar user experience can take place, but the user would not be directly viewing physical objects in the environment, such as table 1129, and would instead be presented with a virtual reconstruction of the table 1129 produced from one or more sensors of the MR device (e.g., an outward facing camera capable of recording the surrounding environment).

The user 1102 can use any of the wrist-wearable device 1126, the AR device 1128 (e.g., through physical inputs at the AR device and/or built-in motion tracking of a user’s extremities), a smart-textile garment, externally mounted extremity tracking device, the HIPD 1142 to provide user inputs, etc. For example, the user 1102 can perform one or more hand gestures that are detected by the wrist-wearable device 1126 (e.g., using one or more EMG sensors and/or IMUs built into the wrist-wearable device) and/or AR device 1128 (e.g., using one or more image sensors or cameras) to provide a user input. Alternatively, or additionally, the user 1102 can provide a user input via one or more touch surfaces of the wrist-wearable device 1126, the AR device 1128, and/or the HIPD 1142, and/or voice commands captured by a microphone of the wrist-wearable device 1126, the AR device 1128, and/or the HIPD 1142. The wrist-wearable device 1126, the AR device 1128, and/or the HIPD 1142 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1128 (e.g., via an input at a temple arm of the AR device 1128). In some embodiments, the user 1102 can provide a user input via one or more facial gestures and/or facial expressions. For example, cameras of the wrist-wearable device 1126, the AR device 1128, and/or the HIPD 1142 can track the user 1102’s eyes for navigating a user interface.

The wrist-wearable device 1126, the AR device 1128, and/or the HIPD 1142 can operate alone or in conjunction to allow the user 1102 to interact with the AR environment. In some embodiments, the HIPD 1142 is configured to operate as a central hub or control center for the wrist-wearable device 1126, the AR device 1128, and/or another communicatively coupled device. For example, the user 1102 can provide an input to interact with the AR environment at any of the wrist-wearable device 1126, the AR device 1128, and/or the HIPD 1142, and the HIPD 1142 can identify one or more back-end and front-end tasks to cause the performance of the requested interaction and distribute instructions to cause the performance of the one or more back-end and front-end tasks at the wrist-wearable device 1126, the AR device 1128, and/or the HIPD 1142. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1142 can perform the back-end tasks and provide the wrist-wearable device 1126 and/or the AR device 1128 operational data corresponding to the performed back-end tasks such that the wrist-wearable device 1126 and/or the AR device 1128 can perform the front-end tasks. In this way, the HIPD 1142, which has more computational resources and greater thermal headroom than the wrist-wearable device 1126 and/or the AR device 1128, performs computationally intensive tasks and reduces the computer resource utilization and/or power usage of the wrist-wearable device 1126 and/or the AR device 1128.

In the example shown by the first AR system 1100a, the HIPD 1142 identifies one or more back-end tasks and front-end tasks associated with a user request to initiate an AR video call with one or more other users (represented by the avatar 1104 and the digital representation of the contact 1106) and distributes instructions to cause the performance of the one or more back-end tasks and front-end tasks. In particular, the HIPD 1142 performs back-end tasks for processing and/or rendering image data (and other data) associated with the AR video call and provides operational data associated with the performed back-end tasks to the AR device 1128 such that the AR device 1128 performs front-end tasks for presenting the AR video call (e.g., presenting the avatar 1104 and the digital representation of the contact 1106).

In some embodiments, the HIPD 1142 can operate as a focal or anchor point for causing the presentation of information. This allows the user 1102 to be generally aware of where information is presented. For example, as shown in the first AR system 1100a, the avatar 1104 and the digital representation of the contact 1106 are presented above the HIPD 1142. In particular, the HIPD 1142 and the AR device 1128 operate in conjunction to determine a location for presenting the avatar 1104 and the digital representation of the contact 1106. In some embodiments, information can be presented within a predetermined distance from the HIPD 1142 (e.g., within five meters). For example, as shown in the first AR system 1100a, virtual object 1108 is presented on the desk some distance from the HIPD 1142. Similar to the above example, the HIPD 1142 and the AR device 1128 can operate in conjunction to determine a location for presenting the virtual object 1108. Alternatively, in some embodiments, presentation of information is not bound by the HIPD 1142. More specifically, the avatar 1104, the digital representation of the contact 1106, and the virtual object 1108 do not have to be presented within a predetermined distance of the HIPD 1142. While an AR device 1128 is described working with an HIPD, an MR headset can be interacted with in the same way as the AR device 1128.

User inputs provided at the wrist-wearable device 1126, the AR device 1128, and/or the HIPD 1142 are coordinated such that the user can use any device to initiate, continue, and/or complete an operation. For example, the user 1102 can provide a user input to the AR device 1128 to cause the AR device 1128 to present the virtual object 1108 and, while the virtual object 1108 is presented by the AR device 1128, the user 1102 can provide one or more hand gestures via the wrist-wearable device 1126 to interact and/or manipulate the virtual object 1108. While an AR device 1128 is described working with a wrist-wearable device 1126, an MR headset can be interacted with in the same way as the AR device 1128.

### Integration of Artificial Intelligence with XR Systems

FIG. 11A illustrates an interaction in which an artificially intelligent virtual assistant can assist in requests made by a user 1102. The AI virtual assistant can be used to complete open-ended requests made through natural language inputs by a user 1102. For example, in FIG. 11A the user 1102 makes an audible request 1144 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 11A also illustrates an example neural network 1152 used in Artificial Intelligence applications. Uses of Artificial Intelligence (AI) are varied and encompass many different aspects of the devices and systems described herein. AI capabilities cover a diverse range of applications and deepen interactions between the user 1102 and user devices (e.g., the AR device 1128, an MR device 1132, the HIPD 1142, the wrist-wearable device 1126). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1102 can interact with an AI model through natural language inputs captured by a voice sensor, text inputs, or any other input modality that accepts natural language and/or a corresponding voice sensor module. In another instance, input is provided by tracking the eye gaze of a user 1102 via a gaze tracker module. Additionally, the AI model can also receive inputs beyond those supplied by a user 1102. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 1128) or from multiple devices that are in communication with each other (e.g., a system that includes at least two of an AR device 1128, an MR device 1132, the HIPD 1142, the wrist-wearable device 1126, etc.). The AI model can also access additional information (e.g., one or more servers 1130, the computers 1140, the mobile devices 1150, and/or other electronic devices) via a network 1125.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1128, an MR device 1132, the HIPD 1142, the wrist-wearable device 1126) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1128, an MR device 1132, the HIPD 1142, the wrist-wearable device 1126), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1142), haptic feedback can provide information to the user 1102. An AI model can also use the inputs described above to determine the appropriate modality and device(s) to present content to the user (e.g., a user walking on a busy road can be presented with an audio output instead of a visual output to avoid distracting the user 1102).

### Example Augmented Reality Interaction

FIG. 11B shows the user 1102 wearing the wrist-wearable device 1126 and the AR device 1128 and holding the HIPD 1142. In the second AR system 1100b, the wrist-wearable device 1126, the AR device 1128, and/or the HIPD 1142 are used to receive and/or provide one or more messages to a contact of the user 1102. In particular, the wrist-wearable device 1126, the AR device 1128, and/or the HIPD 1142 detect and coordinate one or more user inputs to initiate a messaging application and prepare a response to a received message via the messaging application.

In some embodiments, the user 1102 initiates, via a user input, an application on the wrist-wearable device 1126, the AR device 1128, and/or the HIPD 1142 that causes the application to initiate on at least one device. For example, in the second AR system 1100b the user 1102 performs a hand gesture associated with a command for initiating a messaging application (represented by messaging user interface 1112); the wrist-wearable device 1126 detects the hand gesture; and, based on a determination that the user 1102 is wearing the AR device 1128, causes the AR device 1128 to present a messaging user interface 1112 of the messaging application. The AR device 1128 can present the messaging user interface 1112 to the user 1102 via its display (e.g., as shown by user 1102’s field of view 1110). In some embodiments, the application is initiated and can be run on the device (e.g., the wrist-wearable device 1126, the AR device 1128, and/or the HIPD 1142) that detects the user input to initiate the application, and the device provides another device operational data to cause the presentation of the messaging application. For example, the wrist-wearable device 1126 can detect the user input to initiate a messaging application, initiate and run the messaging application, and provide operational data to the AR device 1128 and/or the HIPD 1142 to cause presentation of the messaging application. Alternatively, the application can be initiated and run at a device other than the device that detected the user input. For example, the wrist-wearable device 1126 can detect the hand gesture associated with initiating the messaging application and cause the HIPD 1142 to run the messaging application and coordinate the presentation of the messaging application.

Further, the user 1102 can provide a user input provided at the wrist-wearable device 1126, the AR device 1128, and/or the HIPD 1142 to continue and/or complete an operation initiated at another device. For example, after initiating the messaging application via the wrist-wearable device 1126 and while the AR device 1128 presents the messaging user interface 1112, the user 1102 can provide an input at the HIPD 1142 to prepare a response (e.g., shown by the swipe gesture performed on the HIPD 1142). The user 1102’s gestures performed on the HIPD 1142 can be provided and/or displayed on another device. For example, the user 1102’s swipe gestures performed on the HIPD 1142 are displayed on a virtual keyboard of the messaging user interface 1112 displayed by the AR device 1128.

In some embodiments, the wrist-wearable device 1126, the AR device 1128, the HIPD 1142, and/or other communicatively coupled devices can present one or more notifications to the user 1102. The notification can be an indication of a new message, an incoming call, an application update, a status update, etc. The user 1102 can select the notification via the wrist-wearable device 1126, the AR device 1128, or the HIPD 1142 and cause presentation of an application or operation associated with the notification on at least one device. For example, the user 1102 can receive a notification that a message was received at the wrist-wearable device 1126, the AR device 1128, the HIPD 1142, and/or other communicatively coupled device and provide a user input at the wrist-wearable device 1126, the AR device 1128, and/or the HIPD 1142 to review the notification, and the device detecting the user input can cause an application associated with the notification to be initiated and/or presented at the wrist-wearable device 1126, the AR device 1128, and/or the HIPD 1142.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1128 can present to the user 1102 game application data and the HIPD 1142 can use a controller to provide inputs to the game. Similarly, the user 1102 can use the wrist-wearable device 1126 to initiate a camera of the AR device 1128, and the user can use the wrist-wearable device 1126, the AR device 1128, and/or the HIPD 1142 to manipulate the image capture (e.g., zoom in or out, apply filters) and capture image data.

While an AR device 1128 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 11C-1 and 11C-2, the user 1102 is shown wearing the wrist-wearable device 1126 and an MR device 1132 (e.g., a device capable of providing either an entirely VR experience or an MR experience that displays object(s) from a physical environment at a display of the device) and holding the HIPD 1142. In the third AR system 1100c, the wrist-wearable device 1126, the MR device 1132, and/or the HIPD 1142 are used to interact within an MR environment, such as a VR game or other MR/VR application. While the MR device 1132 presents a representation of a VR game (e.g., first MR game environment 1120) to the user 1102, the wrist-wearable device 1126, the MR device 1132, and/or the HIPD 1142 detect and coordinate one or more user inputs to allow the user 1102 to interact with the VR game.

In some embodiments, the user 1102 can provide a user input via the wrist-wearable device 1126, the MR device 1132, and/or the HIPD 1142 that causes an action in a corresponding MR environment. For example, the user 1102 in the third MR system 1100c (shown in FIG. 11C-1) raises the HIPD 1142 to prepare for a swing in the first MR game environment 1120. The MR device 1132, responsive to the user 1102 raising the HIPD 1142, causes the MR representation of the user 1122 to perform a similar action (e.g., raise a virtual object, such as a virtual sword 1124). In some embodiments, each device uses respective sensor data and/or image data to detect the user input and provide an accurate representation of the user 1102’s motion. For example, image sensors (e.g., SLAM cameras or other cameras) of the HIPD 1142 can be used to detect a position of the HIPD 1142 relative to the user 1102’s body such that the virtual object can be positioned appropriately within the first MR game environment 1120; sensor data from the wrist-wearable device 1126 can be used to detect a velocity at which the user 1102 raises the HIPD 1142 such that the MR representation of the user 1122 and the virtual sword 1124 are synchronized with the user 1102’s movements; and image sensors of the MR device 1132 can be used to represent the user 1102’s body, boundary conditions, or real-world objects within the first MR game environment 1120.

In FIG. 11C-2, the user 1102 performs a downward swing while holding the HIPD 1142. The user 1102’s downward swing is detected by the wrist-wearable device 1126, the MR device 1132, and/or the HIPD 1142 and a corresponding action is performed in the first MR game environment 1120. In some embodiments, the data captured by each device is used to improve the user’s experience within the MR environment. For example, sensor data of the wrist-wearable device 1126 can be used to determine a speed and/or force at which the downward swing is performed and image sensors of the HIPD 1142 and/or the MR device 1132 can be used to determine a location of the swing and how it should be represented in the first MR game environment 1120, which, in turn, can be used as inputs for the MR environment (e.g., game mechanics, which can use detected speed, force, locations, and/or aspects of the user 1102’s actions to classify a user’s inputs (e.g., user performs a light strike, hard strike, critical strike, glancing strike, miss) or calculate an output (e.g., amount of damage)).

FIG. 11C-2 further illustrates that a portion of the physical environment is reconstructed and displayed at a display of the MR device 1132 while the MR game environment 1120 is being displayed. In this instance, a reconstruction of the physical environment 1146 is displayed in place of a portion of the MR game environment 1120 when object(s) in the physical environment are potentially in the path of the user (e.g., a collision with the user and an object in the physical environment are likely). Thus, this example MR game environment 1120 includes (i) an immersive VR portion 1148 (e.g., an environment that does not have a corollary counterpart in a nearby physical environment) and (ii) a reconstruction of the physical environment 1146 (e.g., table 1150 and cup 1152). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1126, the MR device 1132, and/or the HIPD 1142 are described as detecting user inputs, in some embodiments, user inputs are detected at a single device (with the single device being responsible for distributing signals to the other devices for performing the user input). For example, the HIPD 1142 can operate an application for generating the first MR game environment 1120 and provide the MR device 1132 with corresponding data for causing the presentation of the first MR game environment 1120, as well as detect the user 1102’s movements (while holding the HIPD 1142) to cause the performance of corresponding actions within the first MR game environment 1120. Additionally or alternatively, in some embodiments, operational data (e.g., sensor data, image data, application data, device data, and/or other data) of one or more devices is provided to a single device (e.g., the HIPD 1142) to process the operational data and cause respective devices to perform an action associated with processed operational data.

In some embodiments, the user 1102 can wear a wrist-wearable device 1126, wear an MR device 1132, wear smart textile-based garments 1138 (e.g., wearable haptic gloves), and/or hold an HIPD 1142 device. In this embodiment, the wrist-wearable device 1126, the MR device 1132, and/or the smart textile-based garments 1138 are used to interact within an MR environment (e.g., any AR or MR system described above in reference to FIGS. 11A–11B). While the MR device 1132 presents a representation of an MR game (e.g., second MR game environment 1120) to the user 1102, the wrist-wearable device 1126, the MR device 1132, and/or the smart textile-based garments 1138 detect and coordinate one or more user inputs to allow the user 1102 to interact with the MR environment.

In some embodiments, the user 1102 can provide a user input via the wrist-wearable device 1126, an HIPD 1142, the MR device 1132, and/or the smart textile-based garments 1138 that causes an action in a corresponding MR environment. In some embodiments, each device uses respective sensor data and/or image data to detect the user input and provide an accurate representation of the user 1102’s motion. While four different input devices are shown (e.g., a wrist-wearable device 1126, an MR device 1132, an HIPD 1142, and a smart textile-based garment 1138) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1138) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 1138 can be used in conjunction with an MR device and/or an HIPD 1142.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 11A–11C-2 provided above are intended to augment the description provided in reference to FIGS. 1A-10. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
in response to a user performing a selection input:
receiving, from one or more cameras of a head-wearable device worn by the user, image data of a field-of-view of the user, the image data including one or more objects;
receiving, from the head-wearable device, gaze data comprising a user gaze at one or more of the one or more objects;
receiving, from a wrist-wearable device worn by the user, hand gesture data indicating the user performing a selection hand gesture, wherein the selection hand gesture has a gesture size and a gesture shape;
determining, based on the gaze data, the image data, the gesture size, and the gesture shape, at least a portion of the one or more objects; and
presenting, to the user, an indication that the portion of the one or more objects is selected.

2. The method of claim 1, further comprising:
in response to the user performing a second selection input:
receiving, from the one or more cameras of the head-wearable device, second image data, distinct from the image data, of a second field-of-view of the user, the second image data including one or more other objects;
receiving, from the head-wearable device, second gaze data, distinct from the gaze data, comprising a user gaze at one or more of the one or more other objects;
receiving, from the wrist-wearable device worn by the user, second hand gesture data indicating the user performing a second selection hand gesture, wherein the second selection hand gesture has a second gesture size and a second gesture shape;
determining, based on the second gaze data, the second image data, the second gesture size, and the second gesture shape, at least a portion of the one or more other objects; and
presenting, to the user, a second indication that the portion of the one or more other objects is selected.

3. The method of claim 1, further comprising:
before presenting the indication that the portion of the one or more objects is selected, and in response to the user performing another selection input:
receiving, from the head-wearable device, other gaze data comprising a user gaze at another one or more objects of the one or more objects;
receiving, from the wrist-wearable device worn by the user, other hand gesture data indicating the user performing another selection hand gesture, wherein the other selection hand gesture has another gesture size and another gesture shape;
determining, based on the other gaze data, the image data, the other gesture size, and the other gesture shape, at least a portion of the other one or more objects; and
presenting, to the user, the indication that the portion of the one or more objects is selected and another indication that the portion of the other one or more objects is selected.

4. The method of claim 1, further comprising identifying, based on the gaze data, an anchor coordinate based on a time-series of previous gaze data, wherein the selection hand gesture is centered around the anchor coordinate to identify the portion of the one or more objects.

5. The method of claim 1, further comprising:
after presenting the indication to the user, generating, using a large language model, a summary comprising information about the portion of the one or more objects.

6. The method of claim 1, wherein:
the hand gesture data is received over a period of time;
the gaze data is received over the period of time, the gaze data comprising a gaze size and a gaze shape;
the portion of the one or more objects is further determined by the gaze size and the gaze shape; and
in accordance with the period of time exceeding a threshold time, the determination of the portion of the one or more objects is weighted towards the gaze size and the gaze shape rather than the gesture size and the gesture shape.

7. The method of claim 1, wherein:
the selection input is a pinch gesture;
the hand gesture data comprises a continuous gesture while the pinch gesture is held;
the hand gesture data is tracked by an inertial measurement unit (IMU) that uses relative movement in relation to a beginning of the continuous gesture;
the hand gesture data ceases to be tracked when the pinch gesture is released; and
the determination is further based on an average position of the gaze data.

8. The method of claim 1, wherein the indication prompts the user to confirm whether the portion of the one or more objects was correctly selected.

9. A non-transitory computer readable storage medium including executable instructions that, when executed by one or more processors, cause the one or more processors to:
in response to a user performing a selection input:
receive, from one or more cameras of a head-wearable device worn by the user, image data of a field-of-view of the user, the image data including one or more objects;
receive, from the head-wearable device, gaze data comprising a user gaze at one or more of the one or more objects;
receive, from a wrist-wearable device worn by the user, hand gesture data indicating the user performing a selection hand gesture, wherein the selection hand gesture has a gesture size and a gesture shape;
determine, based on the gaze data, the image data, the gesture size, and the gesture shape, at least a portion of the one or more objects; and
present, to the user, an indication that the portion of the one or more objects is selected.

10. The non-transitory computer readable storage medium of claim 9, further comprising executable instructions that, when executed by the one or more processors, cause the one or more processors to:
in response to the user performing a second selection input:
receive, from the one or more cameras of the head-wearable device, second image data, distinct from the image data, of a second field-of-view of the user, the second image data including one or more other objects;
receive, from the head-wearable device, second gaze data, distinct from the gaze data, comprising a user gaze at one or more of the one or more other objects;
receive, from the wrist-wearable device worn by the user, second hand gesture data indicating the user performing a second selection hand gesture, wherein the second selection hand gesture has a second gesture size and a second gesture shape;
determine, based on the second gaze data, the second image data, the second gesture size, and the second gesture shape, at least a portion of the one or more other objects; and
present, to the user, a second indication that the portion of the one or more other objects is selected.

11. The non-transitory computer readable storage medium of claim 9, further comprising executable instructions that, when executed by the one or more processors, cause the one or more processors to:
before presenting the indication that the portion of the one or more objects is selected, and in response to the user performing another selection input:
receive, from the head-wearable device, other gaze data comprising a user gaze at another one or more objects of the one or more objects;
receive, from the wrist-wearable device worn by the user, other hand gesture data indicating the user performing another selection hand gesture, wherein the other selection hand gesture has another gesture size and another gesture shape;
determine, based on the other gaze data, the image data, the other gesture size, and the other gesture shape, at least a portion of the other one or more objects; and
present, to the user, the indication that the portion of the one or more objects is selected and a second indication that the portion of the other one or more objects is selected.

12. The non-transitory computer readable storage medium of claim 9, further comprising executable instructions that, when executed by the one or more processors, cause the one or more processors to:
identify, based on the gaze data, an anchor coordinate, wherein the selection hand gesture is centered around the anchor coordinate to identify the portion of the one or more objects.

13. The non-transitory computer readable storage medium of claim 9, wherein:
the hand gesture data is received over a period of time;
the gaze data is received over the period of time, the gaze data comprising a gaze size and a gaze shape;
the portion of the one or more objects is further determined by the gaze size and the gaze shape; and
in accordance with the period of time exceeding a threshold time, the determination of the portion of the one or more objects is weighted towards the gaze size and the gaze shape rather than the gesture size and the gesture shape.

14. The non-transitory computer readable storage medium of claim 9, wherein:
the selection input is a pinch gesture;
the hand gesture data comprises a continuous gesture while the pinch gesture is held;
the hand gesture data is tracked by an inertial measurement unit (IMU) that uses relative movement in relation to a beginning of the continuous gesture;
the hand gesture data ceases to be tracked when the pinch gesture is released; and
the determination is further based on an average position of the gaze data.

15. A system, comprising:
a head-wearable device including one or more cameras;
a wrist-wearable device;
one or more processors; and
memory including executable instructions that, when executed by the one or more processors, cause the one or more processors to:
in response to a user wearing the head-wearable device and the wrist-wearable device performing a selection input:
receive, from the one or more cameras of the head-wearable device, image data of a field-of-view of the user, the image data including one or more objects;
receive, from the head-wearable device, gaze data comprising a user gaze at one or more of the one or more objects;
receive, from the wrist-wearable device, hand gesture data indicating the user performing a selection hand gesture, wherein the selection hand gesture has a gesture size and a gesture shape;
determine, based on the gaze data, the image data, the gesture size, and the gesture shape, at least a portion of the one or more objects; and
present, to the user, an indication that the portion of the one or more objects is selected.

16. The system of claim 15, wherein the executable instructions further cause the one or more processors to:
in response to the user performing a second selection input:
receive, from the one or more cameras of the head-wearable device, second image data, distinct from the image data, of a second field-of-view of the user, the second image data including one or more other objects;
receive, from the head-wearable device, second gaze data, distinct from the gaze data, comprising a user gaze at one or more of the one or more other objects;
receive, from the wrist-wearable device, second hand gesture data indicating the user performing a second selection hand gesture, wherein the second selection hand gesture has a second gesture size and a second gesture shape;
determine, based on the second gaze data, the second image data, the second gesture size, and the second gesture shape, at least a portion of the one or more other objects; and
present, to the user, a second indication that the portion of the one or more other objects is selected.

17. The system of claim 15, wherein the executable instructions further cause the one or more processors to:
before presenting the indication that the portion of the one or more objects is selected, and in response to the user performing another selection input:
receive, from the head-wearable device, other gaze data comprising a user gaze at another one or more objects of the one or more objects;
receive, from the wrist-wearable device, other hand gesture data indicating the user performing another selection hand gesture, wherein the other selection hand gesture has another gesture size and another gesture shape;
determine, based on the other gaze data, the image data, the other gesture size, and the other gesture shape, at least a portion of the other one or more objects; and
present, to the user, the indication that the portion of the one or more objects is selected and a second indication that the portion of the other one or more objects is selected.

18. The system of claim 15, wherein the executable instructions further cause the one or more processors to:
identify, based on the gaze data, an anchor coordinate, wherein the selection hand gesture is centered around the anchor coordinate to identify the portion of the one or more objects.

19. The system of claim 15, wherein:
the hand gesture data is received over a period of time;
the gaze data is received over the period of time, the gaze data comprising a gaze size and a gaze shape;
the portion of the one or more objects is further determined by the gaze size and the gaze shape; and
in accordance with the period of time exceeding a threshold time, the determination of the portion of the one or more objects is weighted towards the gaze size and the gaze shape rather than the gesture size and the gesture shape.

20. The system of claim 15, wherein:
the selection input is a pinch gesture;
the hand gesture data comprises a continuous gesture while the pinch gesture is held;
the hand gesture data is tracked by an inertial measurement unit (IMU) that uses relative movement in relation to a beginning of the continuous gesture;
the hand gesture data ceases to be tracked when the pinch gesture is released; and
the determination is further based on an average position of the gaze data.
